(19) United States
(12) Patent Application Publication
(10) Pub. No.: US 2026/0290383 A1
(43) Pub. Date: Sep. 24, 2026

(54) SYSTEM

(71) Applicant: SoftBank Group Corp., Tokyo (JP)

(72) Inventor: Seiju MORISHITA, Tokyo (JP)

(73) Assignee: SoftBank Group Corp., Tokyo (JP)

(21) Appl. No.: 19/568,932

(22) Filed: Mar. 17, 2026

(30) Foreign Application Priority Data
Mar. 19, 2025 (JP) 2025-045209

(51) Int. Cl. G10L 25/63; G06F 40/295; G06F 40/30; G06N 3/0475; G10L 15/22; G10L 15/26; G10L 25/30; G10L 25/90

(52) U.S. Cl. CPC G10L 25/63; G06F 40/295; G06F 40/30; G06N 3/0475; G10L 15/22; G10L 15/26; G10L 25/90; G10L 2015/223; G10L 25/30

(57) ABSTRACT

A system includes a processor that is configured to receive an utterance from a user and interpret an intent of the utterance by using a generative AI model, automatically complete a task based on an analysis result obtained from the interpretation of the intent, and recognize an emotion from the utterance of the user and adjust a priority of the task based on the recognized emotion.

### CROSS-REFERENCE TO RELATED APPLICATION

This application is based on and claims priority under 35 USC 119 from Japanese Patent Application No. 2025-045209 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional task management systems and digital assistants generally require a user to explicitly operate dedicated task management interfaces or to issue rigid, predefined commands in order to register, update, or complete tasks. In many cases, such systems are unable to flexibly understand a natural-language utterance of the user, and therefore the user must manually translate their real intention into specific operations such as clicking buttons, filling forms, or selecting menu items. This leads to an increased cognitive load and operational burden on the user, and reduces the efficiency of daily work and communication. Moreover, conventional systems typically do not consider the emotional state of the user that is reflected in the user's utterance. Even when a user expresses urgency, frustration, stress, or other emotions, most systems treat all tasks equally based only on static attributes such as due dates or preset priorities. As a result, task prioritization in such systems fails to reflect the real, context-dependent needs and mental state of the user, which may cause important or psychologically stressful tasks to be postponed inappropriately.

In addition, when a user intends to perform schedule management or information retrieval via natural-language utterances within ordinary communication tools, conventional systems often cannot automatically determine that the utterance relates to scheduling or searching. The user is therefore forced to switch to a separate calendar tool or search interface, and to input the same content again in a structured format. This context switching between tools and repetitive input causes inefficiency and interrupts the user's workflow.

Accordingly, there is a need for a system that can: (i) receive a natural-language utterance from a user and understand the user's intent by using a generative AI model, (ii) automatically complete tasks based on the analysis result of the utterance, (iii) recognize the emotion included in the utterance and adjust task priorities based on the recognized emotion, and (iv) automatically perform schedule management and information retrieval when the utterance relates to such operations. By providing such a system, it becomes possible to reduce the operational burden on the user, to optimize task execution in accordance with the user's emotional state, and to improve the overall efficiency and usability of task and information management.

### SUMMARY

In order to solve the above-described problems, a system according to at least one embodiment of the present invention comprises a processor, wherein the processor is configured to receive an utterance from a user and interpret an intent of the utterance by using a generative AI model, to automatically complete a task based on an analysis result obtained from the interpretation of the intent, and to recognize an emotion from the utterance of the user and adjust a priority of the task based on the recognized emotion.

More specifically, in the system according to at least one embodiment, the processor receives, via a communication interface, a natural-language utterance that the user inputs through a communication tool, an email client, or a similar application. The processor then applies a generative AI model to the utterance to perform natural-language understanding, thereby interpreting the intent of the utterance, such as a request for execution, update, or completion of a specific task. Based on the analysis result including the interpreted intent and associated parameters, the processor automatically performs processing to complete or update one or more tasks, without requiring the user to perform explicit, manual task operations through a dedicated task management interface.

Furthermore, in the system according to at least one embodiment, the processor analyzes linguistic features of the utterance, such as word choice, expressions of urgency, sentence structure, and other contextual information, in order to recognize an emotion of the user, for example, stress, urgency, satisfaction, or anxiety. The processor adjusts a priority of one or more tasks according to the recognized emotion, for instance, by raising the priority of tasks associated with a highly urgent or stressful utterance, and by recalculating an execution order among a plurality of tasks. By doing so, the system dynamically optimizes task prioritization so that it reflects both objective information such as deadlines and subjective information such as the user's emotional state.

In addition, in the system according to at least one embodiment, when the utterance of the user relates to schedule management, the processor is configured to automatically set a schedule corresponding to the utterance. For example, when the utterance includes a request to set a meeting or an appointment, together with conditions such as date, time range, duration, or participants, the processor automatically generates and registers a schedule entry in a calendar system based on the analysis result of the utterance. Consequently, the user can perform schedule management without manually operating a calendar interface.

Moreover, in the system according to at least one embodiment, when the utterance of the user relates to information retrieval, the processor is configured to automatically propose information corresponding to the utterance. In this case, the processor interprets the content of the utterance as a search query, accesses an internal or external information source, and retrieves one or more pieces of information that match the query. The processor then provides the retrieved information to the user as a proposal, thereby enabling the user to perform information retrieval within the same utterance-based interaction, without switching to a separate search tool or interface.

Through the above-described configuration, the system according to the present invention enables integrated processing in which the processor interprets the user's intent using a generative AI model, automatically completes tasks, recognizes the user's emotion from the utterance, adjusts task priorities based on the recognized emotion, and further performs automatic schedule setting and information proposal when the utterance relates to schedule management or information retrieval. As a result, the system reduces the user's operational burden, reflects the user's real needs and emotional state in task prioritization, and significantly improves the efficiency and usability of task, schedule, and information management.

The term “system” refers to an arrangement of one or more hardware devices and software components that cooperatively perform processing operations, including at least one processor configured to execute instructions for realizing the functions described in the claims.
The term “processor” refers to any hardware logic device or combination of devices capable of executing instructions, such as a central processing unit (CPU), a graphics processing unit (GPU), an application specific integrated circuit (ASIC), a field programmable gate array (FPGA), or a system on a chip (SoC).
The term “user” refers to a human operator who interacts with the system by providing utterances and receiving responses, and for whom tasks, schedules, or information retrieval results are managed by the system.
The term “utterance” refers to any user-provided natural-language input, including spoken language converted to text or text entered directly, that is processed by the system to interpret an intent, recognize an emotion, and trigger subsequent operations.
The term “generative AI model” refers to a machine-learning model, such as a large language model or a neural network model, that is configured to generate or transform natural-language text and to perform understanding of user utterances, including intent interpretation based on learned patterns.
The term “intent” refers to a semantic representation of what the user wishes the system to do, such as completing a task, setting a schedule, or searching for information, as interpreted by the generative AI model from the user's utterance.
The term “analysis result” refers to data derived from processing the user's utterance with the generative AI model, including at least the interpreted intent and optionally parameters such as target tasks, dates, times, entities, or other contextual information.
The term “task” refers to a unit of work or an action item to be performed by or for the user, such as preparing a document, attending a meeting, responding to a message, or any other definable activity managed by the system.
The term “automatically complete a task” refers to the processor performing one or more operations without requiring explicit, manual task operations from the user, such as marking a task as done, updating task attributes, creating related entries, or executing associated system actions based on the analysis result.
The term “emotion” refers to an estimated affective state of the user, such as urgency, stress, frustration, satisfaction, or calmness, inferred by the processor from the linguistic and contextual features of the user's utterance.
The term “recognize an emotion” refers to the processor identifying or classifying the user's emotional state from the user's utterance, for example by applying machine-learning models or rule-based analysis to the text or its features.
The term “priority of the task” refers to an order or level indicating the relative importance, urgency, or execution sequence of one or more tasks, which is used by the system to determine which tasks should be handled earlier or receive more attention.
The term “adjust a priority of the task” refers to the processor changing, recalculating, or reordering the priority values or ranking of one or more tasks in response to the recognized emotion or the analysis result of the user's utterance.
The term “schedule management” refers to operations related to planning and handling time-based events for the user, including creating, updating, or canceling calendar entries such as meetings, appointments, or reminders.
The term “automatically set a schedule” refers to the processor creating or modifying a calendar entry corresponding to the user's utterance, including determining at least one of a date, time, duration, or participants, without requiring the user to manually operate a separate calendar interface.
The term “information retrieval” refers to the process of searching for and obtaining relevant information from one or more data sources, such as document repositories, databases, or web services, in response to a query derived from the user's utterance.
The term “automatically propose information” refers to the processor retrieving one or more pieces of information corresponding to the user's utterance and presenting the retrieved information to the user, without requiring the user to manually construct and submit a separate search query.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

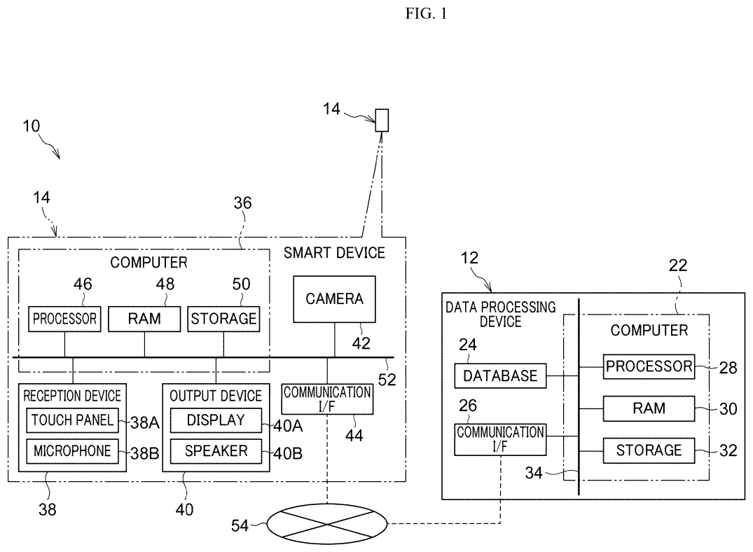

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

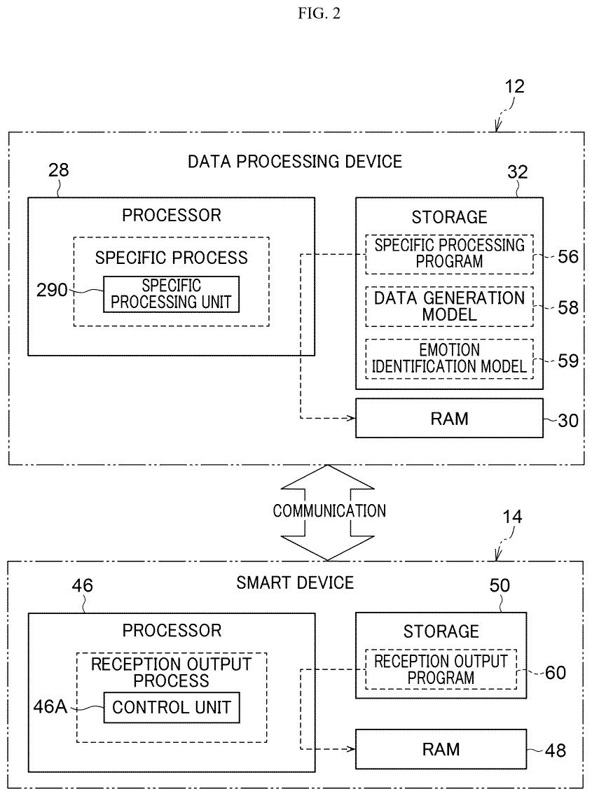

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In contemporary computing environments, end users increasingly rely on multiple heterogeneous communication platforms, schedule management applications, information management applications, and task management applications. Conventional systems typically require the user to manually operate each application, interpret natural language instructions, and translate such instructions into concrete configurations such as calendar events, document search queries, and task sorting conditions. In particular, when the user expresses a complex instruction in natural language, for example combining time conditions, participant constraints, document attributes, or task urgency, a conventional system either ignores the complexity or requires the user to perform multiple separate operations across different user interfaces. This leads to fragmented workflows, increased cognitive load on the user, and inefficient utilization of computing resources.

Furthermore, known conversational systems that employ natural language processing often treat the generated natural-language result as an endpoint, rather than as a controller for deeper, structured interactions with external management components. Such systems typically do not derive sufficiently rich structured data from user utterances to drive multi-step orchestration across schedule management, information management, and task management components. As a result, these systems cannot reliably compute optimal meeting time slots across multiple entities, cannot robustly narrow down information items based on temporal and semantic conditions, and cannot dynamically recalculate task priorities based on explicit and implicit constraints.

Additionally, existing architectures usually embed task-specific logic directly into application code, resulting in rigid, service-specific implementations that are difficult to extend or adapt to new services. This leads to poor scalability and maintainability of the software. In particular, conventional systems lack a unified mechanism that (i) converts a user utterance into abstract internal action plan data, (ii) coordinates multiple external management units based on that plan, and (iii) uses a generative AI model both for intent/parameter extraction and for generating natural-language explanations from structured execution results. Accordingly, conventional systems fail to fully exploit generative AI capabilities for improving the internal operation of the computer, including data structuring, scheduling computation, filtering and ranking, and generation of coherent notification messages.

Moreover, while generative AI models have been used to answer questions or draft texts, their integration with external schedule, information, and task management units has often been limited to simple API triggers without deeper feedback loops. There is typically no systematic mechanism for re-feeding structured, ranked results into the generative AI model to obtain refined natural-language summaries tailored to complex user contexts. This results in suboptimal user guidance, ambiguous explanations, and unnecessary follow-up interactions, thereby degrading the overall efficiency and responsiveness of the computing system.

Therefore, there is a need for an improved computer-implemented system that uses a generative AI model not only to understand user utterances but also to generate and manipulate structured data representing internal action plans; to coordinate heterogeneous external management units; to compute, in an automated and optimized fashion, common free time periods for meetings, relevant information items, and prioritized tasks; and to convert the resulting structured data into concise, context-aware natural-language messages. Such a system should reduce the number of manual operations required by the user, improve the accuracy and consistency of the execution of user intent across different services, and enhance the overall performance and usability of the computing environment.

The specific processing by the specific processing unit 290 of the data processing device 12 in Example 1 is realized by the following means.

The present invention provides a server comprising a processor and a communication unit, wherein the processor is configured to receive utterance data of a user from a terminal of the user via the communication unit, normalize the utterance data as character string data, and store the character string data; to transmit the character string data, as a prompt sentence, to a natural language processing unit including a generative AI model, and obtain, from the generative AI model, an analysis result as structured data including at least an intent type, time information, target information, participant information, and priority information; to generate internal action plan data including at least an action type, a service type to be used, a processing target period, and a processing target set in accordance with the intent type included in the structured data, and store the internal action plan data in a storage unit; to transmit an inquiry request, based on the internal action plan data, via an external communication interface to at least one of a schedule management unit, an information management unit, and a task management unit, and acquire at least one of schedule data, information data, and task data; to derive a common free time period by comparing, on a time axis, occupied time periods of a plurality of entities included in the acquired schedule data, and to determine a continuous time period corresponding to a predetermined time length so as to automatically set a meeting schedule; to perform a search process and a relevance evaluation process on creation time information and content information included in the acquired information data, and to automatically specify, as a presentation candidate, an information item that most closely matches the target information and the time information included in the structured data; to perform extraction processing and sorting processing on due date information and status information included in the acquired task data, and to automatically rearrange tasks due on a current date or overdue tasks in ascending order of their due dates so as to determine task priorities; to generate a prompt sentence using structured data including at least one of the meeting schedule, the presentation candidate, and the task priorities, to input the prompt sentence to the generative AI model, and to obtain a natural-language notification message to be presented to the user; and to transmit the natural-language notification message to the terminal of the user via the communication unit. This enables the computer system to internally transform unstructured natural language utterances into rich, structured control data that drives coordinated interactions with heterogeneous management units, to perform complex computations such as multi-entity scheduling, relevance-based information selection, and dynamic task prioritization within the server, and to generate concise, context-aware natural-language messages based on the computed structured results, thereby improving the efficiency, accuracy, and scalability of the underlying computer technology and reducing the operational burden on the user.

The term “utterance data” refers to digital data representing a user's natural-language input, including at least text obtained from a communication application and optionally text converted from a user's speech, which is received by the server for further processing.
The term “terminal” refers to an information processing device operated by a user, such as a general-purpose computer, a mobile communication device, or a web-enabled device, that transmits user utterance data to the server and displays responses from the server.
The term “communication unit” refers to a functional component, implemented by hardware, software, or a combination thereof, that enables data exchange between the server and external devices or services via a communication network using protocols such as HTTP, HTTPS, or other network protocols.
The term “character string data” refers to data composed of one or more characters encoded in a predetermined character encoding scheme, representing the normalized textual form of the user's utterance.
The term “normalize” refers to processing that converts input data into a standardized internal representation, including at least unifying character encoding, removing or adjusting control characters or extra spaces, and optionally applying text normalization rules such as case normalization or Unicode normalization.
The term “natural language processing unit” refers to a functional component, which may be implemented as one or more software modules and/or external services, that analyzes natural-language text to derive semantic or syntactic information, including at least an intent type and associated parameters.
The term “generative AI model” refers to a machine-learned model capable of generating or transforming natural-language text or structured data in response to input text or structured data, including but not limited to large language models that produce analysis results or notification messages based on prompt sentences.
The term “prompt sentence” refers to a piece of text or structured textual instruction provided as input to a generative AI model, the content of which specifies a task, a desired output format, or conditions for generating or transforming text or structured data.
The term “analysis result” refers to information output by the natural language processing unit or the generative AI model based on the user's utterance, including at least semantic attributes such as an intent type, time information, target information, participant information, and priority information.
The term “structured data” refers to data organized in a predetermined format, such as key-value pairs, records, or hierarchical data structures, that allows individual attributes (for example, intent type or time information) to be programmatically accessed and processed.
The term “intent type” refers to a classification label indicating the general purpose or category of a user's utterance, such as scheduling, information retrieval, or task management, which is used by the server to determine an appropriate processing flow.
The term “time information” refers to data describing temporal aspects extracted from a user's utterance, such as dates, time ranges, deadlines, or periods (for example, “this week” or “today”), expressed in a form that can be used for further computation.
The term “target information” refers to data representing an object or subject to which a user's utterance pertains, such as a document, a meeting, a project, or a task, and is used for specifying items in schedule data, information data, or task data.
The term “participant information” refers to data indicating entities involved in a requested operation, such as persons or groups participating in a meeting, which can be mapped to internal identifiers of accounts or resources in external services.
The term “priority information” refers to data indicating the relative importance or urgency of tasks or operations, which may be explicitly stated in the user's utterance or inferred by the natural language processing unit or generative AI model.
The term “internal action plan data” refers to structured data generated by the processor that represents an abstract plan for processing a user's request, including at least an action type, a service type to be used, a processing target period, and a processing target set.
The term “action type” refers to a category of processing operation to be executed by the server, such as creating a schedule entry, retrieving information, or rearranging tasks, derived from the intent type in the analysis result.
The term “service type” refers to a classification of an external management unit or external application that is selected to execute a part of the internal action plan, such as a schedule management unit, an information management unit, or a task management unit.
The term “processing target period” refers to temporal range data in the internal action plan that specifies the time interval within which schedule data, information data, or task data should be considered, such as a particular day or week.
The term “processing target set” refers to a set of entities or items, such as a set of users, documents, or tasks, that are designated in the internal action plan as the scope of processing. The term “storage unit” refers to a memory device or storage subsystem, implemented by physical or virtual storage resources, that retains character string data, internal action plan data, and other intermediate or final data used by the server.
The term “external communication interface” refers to a functional interface within the server that sends and receives data to and from external systems, including schedule management units, information management units, and task management units, using predetermined communication protocols and application programming interfaces.
The term “schedule management unit” refers to an external or internal system or module that stores and manages schedule data related to time-based events, such as calendar entries, and responds to inquiries from the server.
The term “information management unit” refers to an external or internal system or module that stores and manages information data such as digital documents, records, or files, and provides search or retrieval functions.
The term “task management unit” refers to an external or internal system or module that stores and manages task data, including task titles, due dates, and statuses, and supports listing, updating, and sorting operations.
The term “schedule data” refers to data representing scheduled events, including at least start times, end times, and associated entities, which is retrieved from a schedule management unit for analysis or modification.
The term “information data” refers to data representing stored information items, such as documents or records, including attributes like creation time, modification time, and content-related metadata.
The term “task data” refers to data representing tasks, including at least task descriptions, due dates, and status indicators, retrieved from a task management unit and used for prioritization or other manipulations.
The term “occupied time period” refers to a time interval in schedule data during which a particular entity, such as a user or resource, is already committed to an existing event and is therefore not available for another meeting or event.
The term “common free time period” refers to a time interval computed by comparing occupied time periods of multiple entities, the interval being available for all entities simultaneously and usable for scheduling a new event.
The term “continuous time period corresponding to a predetermined time length” refers to a time interval of at least a specified duration, without interruption, within a common free time period, suitable for scheduling an event such as a meeting.
The term “meeting schedule” refers to schedule data representing a planned meeting event that has been automatically set by the processor based on a common free time period and associated participant information.
The term “creation time information” refers to metadata associated with information data that indicates when a particular information item, such as a document or record, was created or initially stored.
The term “content information” refers to data describing the substance of an information item, which may include titles, body text, summaries, tags, or other descriptive features used in search and relevance evaluation.
The term “presentation candidate” refers to an information item selected by the processor as a likely match to the user's request, based on search and relevance evaluation performed on information data.
The term “due date information” refers to data associated with a task that specifies a point in time or a date by which the task is intended to be completed.
The term “status information” refers to data that indicates the current state of a task, such as not started, in progress, completed, or overdue.
The term “task priorities” refers to an ordered arrangement of tasks determined by the processor, wherein tasks are arranged based on due date information, status information, or other criteria indicating their relative urgency or importance.
The term “natural-language notification message” refers to a text message in a natural language generated for presentation to the user, which explains or confirms processing results such as meeting schedules, selected information items, or task priorities.
The term “confirmation message” refers to a type of natural-language notification message that informs the user of the completion or registration of a specific operation, such as the scheduling of a meeting.
The term “explanatory text of a retrieval result” refers to a natural-language notification message that explains which information item or items were selected as relevant to the user's request and on what basis.
The term “summary text of the task priorities” refers to a natural-language notification message that concisely describes the ordering of tasks and their relative urgency, based on the task priorities computed by the processor.

In one embodiment, a server implements the claimed system as a network-accessible computing apparatus including at least one processor, a main memory, a non-volatile storage device, and a communication interface. The server executes control software on an operating system such as a general-purpose server operating system. The server communicatively connects to one or more terminals operated by users via a communication network using protocols such as HTTP or HTTPS.

The server operates together with one or more external management systems that act as a schedule management unit, an information management unit, and a task management unit. Each of these units can be realized by an application executing on a remote computing platform and exposing an application programming interface (API). The server accesses such APIs through the communication interface and processes data returned in a structured format such as key-value records or hierarchical structures.

The server stores, in the non-volatile storage device, a program that causes the processor to perform the functions recited in the claims. The program defines a set of software modules, including a communication module, a normalization module, a prompt-generation module, an analysis interface module, an internal action planner module, a schedule computation module, a relevance evaluation module, a task prioritization module, and a response generation module. The server further stores configuration data identifying, for each user, which external schedule management unit, information management unit, and task management unit should be accessed, and stores authentication information such as API tokens for accessing those units.

The server uses a generative AI model as part of the natural language processing unit. In one embodiment, the generative AI model is implemented as a transformer-based neural network having multiple layers of self-attention and feed-forward sub-layers, with parameters (weights and biases) trained on large-scale text corpora. The model accepts a sequence of tokens as input and outputs either a sequence of tokens representing natural-language text or a sequence representing a structured description. The server stores, in memory, a tokenizer implementing subword segmentation (for example, byte-pair encoding) and converts normalized character string data into token identifiers before transmission to the generative AI model service. The server may host the generative AI model locally or may interact with a remote generative AI service via an API.

The server, in the normalization module, applies deterministic text normalization rules to received character string data. The server unifies character encoding to a single internal encoding, removes control characters that are not required for semantic interpretation, and applies case conversion when appropriate. The server may additionally normalize punctuation, expand standardized abbreviations, and unify date expressions to a canonical form where possible. This normalization reduces the variability of input and improves the stability of downstream analysis, thereby reducing processing errors and enhancing the computational efficiency of intent and parameter extraction.

The server uses the analysis interface module to convert normalized character string data into a prompt sentence for the generative AI model. In one example, the server constructs a prompt sentence in natural language that explicitly instructs the generative AI model to output a constrained structure. For instance, the server can construct the following prompt sentence:

“Analyze the following user utterance. Identify the intent type, time information, target information, participant information, and priority information. Return the result in plain English, clearly labeling each field.

### Utterance:

Please set a one-hour meeting sometime this week when everyone on the team is free.”

The server may alternatively construct a prompt sentence focusing solely on classification, such as:
“Classify the following user utterance into one of: SCHEDULE,
INFORMATION RETRIEVAL, or TASK_MANAGEMENT. Utterance: Please set a one-hour meeting sometime this week when everyone on the team is free.”

By constraining the format and content through such prompt sentences, the server enforces non-conventional, rule-based usage of the generative AI model. The server parses the model's output using deterministic parsers tailored to the expected patterns, thereby converting the model's free-form text into internal structured data. This architecture differs from typical purely conversational use, because the generative AI model is actively controlled to produce machine-readable control data that drives subsequent algorithmic processing.

The server, in the internal action planner module, uses the analysis result to generate internal action plan data. The server defines, in memory, a specific data structure for the internal action plan, including fields such as action type, service type, processing target period, and processing target set. The server applies pre-defined mapping rules to map an intent type indicating schedule management to an action type indicating creation of schedule entries and a service type indicating use of the schedule management unit associated with the user. The server further uses time information to compute a concrete processing target period, such as converting the expression “this week” into start and end timestamps based on the system clock. Participant information is mapped to a processing target set by resolving roles like “team members” or “project group” into internal identifiers using external directory queries. This rule-based transformation of high-level semantic attributes into a compact internal control structure improves the consistency and reusability of control logic and reduces the number of direct service-specific branches in the code, thereby improving the scalability of the software architecture.

The server, in the schedule computation module, implements an algorithm that computes a common free time period from schedule data retrieved from the schedule management unit.

The server receives schedule data for multiple entities, each schedule comprising a collection of time intervals representing occupied periods. The server sorts these intervals on a unified time axis and performs an interval union operation for each entity to merge overlapping events. The server then computes, for a defined processing target period, a set of free intervals by subtracting the union of occupied intervals from the overall period for each entity. The server then intersects the free intervals of all involved entities by iteratively computing overlap between free intervals across users. The server uses an efficient algorithm that processes intervals in chronological order, thereby reducing computational complexity and improving performance relative to naive sampling-based approaches. This interval-based algorithm not only increases processing speed but also reduces memory usage, providing a concrete technical improvement in how schedule data is processed.

The server can then perform an additional step of scanning the resulting common free intervals for a continuous time period whose length is at least a predetermined duration, such as one hour. The server applies heuristic rules, such as preferring time periods during working hours or minimizing fragmentation across time zones, which can be parameterized. By relying on mathematically defined interval operations instead of manual inspection by a human operator, the server can compute optimized meeting schedules much faster and with fewer conflicts. This algorithmic processing of schedule data constitutes a technical solution to a problem rooted in computer scheduling, rather than a mere automation of human calendaring.

The server, in the relevance evaluation module, performs structured search and ranking on information data retrieved from the information management unit. The server uses creation time information to filter information items to a target period, such as “last week,” and uses content information (titles, descriptions, or text excerpts) to compute similarity scores to the target information extracted from the analysis result. The server may employ a combination of keyword matching and vector-based similarity. In one embodiment, the server represents each document and the user's query as high-dimensional vectors using an embedding model, which may also be implemented as a neural network trained on text pairs. The server uses a similarity metric such as cosine similarity to compute a relevance score. The server sorts information items by relevance score and selects the highest-ranked item as the presentation candidate. By combining temporal filtering with semantic similarity evaluation, the server reduces the candidate space and increases the precision of retrieval, achieving measurable improvements over simple keyword search in terms of retrieval accuracy and user effort.

The server similarly processes task data in the task prioritization module. The server parses due date information using standardized date parsing routines and converts all due dates into comparable timestamps. The server filters tasks whose due dates are on the current date or earlier, and orders them by ascending due date. The server may additionally adjust priority based on status information (for example, excluding completed tasks or downgrading low-importance tasks). The server then generates an ordered list representing task priorities. This ordered list is a compact data structure that the response generation module can use to construct a human-readable summary. By centralizing this logic on the server, the system can consistently apply the same prioritization strategy across multiple external task management units, thereby improving the technical consistency and predictability of task ordering.

The server, in the response generation module, uses the generative AI model to convert structured results such as meeting schedule details, presentation candidates, and prioritized task lists into natural-language notification messages. The server constructs prompt sentences that explicitly describe the structured data and request a short, user-appropriate message. For example, the server may generate the following prompt sentence:
“Generate a concise confirmation message for the user. The system has scheduled a one-hour meeting for all team members on Thursday from 10:00 to 11:00. The message should clearly state the date, time, and participants.”

In another example, the server may use:
“Summarize the following task list for today, ordered by urgency: 1) Submit report (due 10:00), 2) Review design (due 15:00), 3) Prepare slides (due 18:00). Produce a short message explaining which task should be done first and why.”

By providing detailed, structured content within the prompt sentence and controlling the expected style and length, the server ensures that the generative AI model operates as a specialized text generator rather than a general conversational agent. The server then returns the generated notification message to the user's terminal via the communication unit.

The server can be implemented with multiple configurations of the generative AI model. In one configuration, the server accesses an external large-scale generative AI system via an API, with the server forming and sending prompt sentences and receiving plain-text responses. In another configuration, the server hosts a smaller, fine-tuned generative AI model locally using an accelerator device such as a graphics processing module or tensor-processing module. The local model can be trained or fine-tuned using supervised learning, where training data comprises pairs of input text (user utterances and structured data) and desired outputs (label sets and notification messages). The server uses an error function such as cross-entropy over token sequences and updates the model parameters using gradient-based optimization. Data augmentation techniques, such as paraphrasing utterances or sampling slight variations of task lists, may be used to improve the robustness of the model. By hosting or controlling the model, the server can further reduce network latency and communication overhead, improving response speed.

The server uses a modular, pipeline-based data flow, in which the output of one module becomes the input of another. The server defines clear intermediate data structures for normalized text, analysis results, internal action plan data, retrieved schedule data, information data, task data, computed common free time periods, relevance-ranked information, and prioritized tasks. This structured data flow allows the server to detect inconsistencies at intermediate stages, perform caching of intermediate results, and parallelize certain operations, such as fetching schedule data for multiple entities concurrently. Such architectural choices provide measurable technical effects, including reduced overall response time, better resource utilization, and improved reliability.

The server, by combining rule-based pre- and post-processing with neural generative text analysis and generation, departs from conventional systems that simply pass user utterances to a model and display the model's replies. Instead, the server uses the generative AI model in a controlled, non-conventional manner: to extract specific control parameters from natural language and to generate explanatory messages from internal control structures. The internal action plan data serves as a stable, machine-readable representation that decouples user-facing expressions from backend service operations. This decoupling improves the adaptability of the system when new services are introduced or when service APIs change, thereby enhancing maintainability and extensibility.

The server achieves technical effects beyond mere automation of human workflows. By transforming unstructured text into structured control data and by executing optimized algorithms for interval computation, semantic ranking, and task ordering, the server reduces the computational resources needed to achieve the same level of precision, improves the speed of complex operations such as multi-entity scheduling, and lowers the risk of human error. Furthermore, by reducing redundant requests to external services through caching of intermediate plan data and results, the server can decrease network traffic and lower the communication load. These effects collectively improve the functioning of the computer system itself.

The terminal, in an embodiment, is realized by a user-operated device such as a smartphone, tablet, or personal computer executing a communication application. The terminal transmits user utterance data to the server via the communication network and displays the natural-language notification messages received from the server. The terminal may also use built-in speech-recognition functionality to convert spoken commands to text before transmission.

The terminal can open hyperlinks included in notification messages to display schedule entries in a calendar application, documents in a viewer, or tasks in a task management client.

The user, in operation, inputs natural-language utterances through the terminal without needing to know the internal data structures or the precise API calls to each external management unit. The user can, for example, say or type:
“Please set a one-hour meeting sometime this week when everyone on the team is free.”
“Where is the design document I created last week?”
“Prioritize my tasks for today by the nearest deadline and tell me.”

The server interprets these utterances using the generative AI model and its algorithmic modules and returns concrete, technically computed results to the user, such as automatically scheduled meetings, document links, and prioritized task lists. Because the server's internal architecture applies specific data structures, optimization algorithms, and controlled interactions with the generative AI model, the system provides improved computer performance and enhanced reliability in executing complex multi-service operations, thereby enabling practical realization of the claimed invention across various deployment environments.

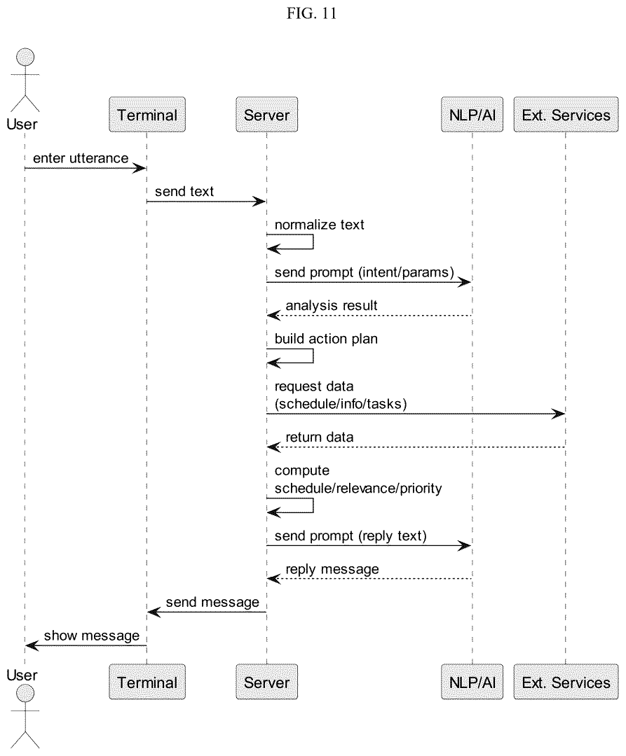

The following describes the processing flow using FIG. 11.

### Step 1:

User inputs a natural-language utterance.

User operates a terminal and inputs an utterance related to scheduling, information retrieval, or task management. User may type text in a communication application or speak into a microphone so that the terminal converts speech to text.
Input: human speech or typed text.
Output: text data representing the user's utterance displayed on the terminal and ready to be transmitted to the server.

### Step 2:

Terminal transmits utterance data to the server.

Terminal sends the text data to the server via a communication network using a protocol such as HTTPS. Terminal embeds the text, user identifier, and context information (for example, conversation ID or channel ID) in a structured message and posts it to a server endpoint.
Input: text data of the utterance and metadata on the terminal.
Output: network request containing the utterance data and metadata delivered to the server.

### Step 3:

Server receives and normalizes the utterance data.

Server receives the network request through a communication unit and extracts the text field and associated metadata. Server performs normalization by converting characters to a unified encoding, trimming leading and trailing spaces, normalizing whitespace sequences, and optionally converting full-width and half-width characters or normalizing Unicode forms. Server stores the normalized character string in a memory area for further processing.
Input: raw text data and metadata received from the terminal.
Output: normalized character string data and associated metadata stored in server memory.

### Step 4:

Server generates a prompt sentence for intent and parameter extraction.

Server constructs a prompt sentence that embeds the normalized character string and explicitly instructs a generative AI model to identify the intent type and related parameters. Server concatenates fixed instruction segments with the user utterance and includes explicit labels to guide the expected output structure. For example, server generates:
“Analyze the following user utterance. Identify the intent type, time information, target information, participant information, and priority information. Return the result in plain English, clearly labeling each field.

### Utterance:

[normalized user text]”
Input: normalized character string data and template instructions.
Output: prompt sentence text suitable for submission to the generative AI model.

### Step 5:

Server transmits the prompt sentence to the generative AI model and receives an analysis result.

Server sends the prompt sentence to a natural language processing unit that includes a generative AI model through an API. Server may convert the prompt sentence into token identifiers using a tokenizer before transmission. The generative AI model processes the token sequence using its neural network layers, computes attention weights, and generates an output sequence representing labeled fields for intent type, time information, target information, participant information, and priority information. Server receives the output as text and parses it using deterministic rules or pattern matching to extract structured attributes.
Input: prompt sentence for the generative AI model.
Output: analysis result as structured data including at least intent type, time information, target information, participant information, and priority information.

### Step 6:

Server generates internal action plan data based on the analysis result.

Server reads the structured attributes from the analysis result and maps them to an internal action plan data structure. Server determines an action type (for example, schedule creation, information retrieval, or task prioritization) from the intent type. Server determines a service type to be used by referencing user-specific configuration data that associates the user with particular schedule management, information management, and task management units.

Server converts time information into a processing target period by computing concrete start and end timestamps using calendar computations. Server resolves participant information into a processing target set by querying a user directory or group membership records to obtain internal identifiers. Server then assembles these values into an internal action plan record and stores it in a storage unit.
Input: structured analysis result and user configuration data.
Output: internal action plan data including action type, service type, processing target period, and processing target set.

### Step 7:

Server requests external data from management units according to the internal action plan.

Server examines the action type and service type in the internal action plan and selects one or more external management units to contact. Server constructs request parameters, such as the processing target period and processing target set, and sends API requests via the external communication interface to a schedule management unit, an information management unit, and/or a task management unit. Each external unit processes the request and returns structured data, such as event lists, document metadata, or task records. Server collects these responses and stores them in working memory.
Input: internal action plan data.
Output: acquired external data including at least one of schedule data, information data, and task data.

### Step 8:

Server computes common free time periods and meeting schedules when scheduling is required.

Server uses the schedule data returned from the schedule management unit and the processing target period and processing target set from the internal action plan. Server for each entity merges overlapping busy intervals into a canonical form and subtracts the merged busy intervals from the processing target period to obtain free intervals. Server then computes the intersection of free intervals across all entities to derive common free time periods. Server scans the resulting common free intervals to locate a continuous time period whose length is at least a specified meeting duration. Server selects an optimal time period based on predefined rules, such as preferring earlier slots or work-hour constraints, and assembles meeting schedule data including start time, end time, and participant identifiers.
Input: schedule data from multiple entities and internal action plan parameters including processing target period and required duration.
Output: computed common free time periods and a selected meeting schedule.

### Step 9:

Server evaluates relevance and selects a presentation candidate when information retrieval is required.

Server applies temporal filtering to information data by discarding items whose creation time information falls outside the processing target period. Server then computes relevance between remaining information items and the target information derived from the analysis result. Server may tokenize document titles and descriptions and compute term-frequency-based scores or obtain semantic embeddings for documents and the query and compute similarity values. Server sorts the information items in descending order of relevance score and selects the top-ranked item as a presentation candidate.
Input: information data from the information management unit, processing target period, and target information.
Output: a ranking of information items and a selected presentation candidate.

### Step 10:

Server prioritizes tasks when task management is required.

Server parses due date information for each task and converts it to a standardized timestamp.

Server compares each due date to the current date and filters tasks that are due on the current date or earlier. Server inspects status information to exclude or de-emphasize completed tasks. Server sorts the remaining tasks by due date in ascending order, optionally applying additional priority weights if priority information is present in the analysis result. Server generates an ordered list of tasks representing task priorities for the user.
Input: task data from the task management unit, current date, and priority-related attributes.
Output: a prioritized list of tasks representing task priorities.

### Step 11:

Server generates a prompt sentence for response generation based on structured results. Server collects the structured results, such as meeting schedule details, the presentation candidate, and the prioritized task list, and constructs a descriptive input for the generative AI model. Server generates a prompt sentence that describes the structured data and instructs the model to produce a concise, user-friendly notification. For example, server may generate: “Generate a short confirmation message to the user. The system has scheduled a one-hour meeting for all team members on Thursday from 10:00 to 11:00. Please clearly state the date, time, and participants.”

### Or:

“Summarize the following tasks for today ordered by urgency: Submit report (due 10:00), Review design (due 15:00), Prepare slides (due 18:00). Explain briefly which task is most urgent.”
Input: structured internal results (meeting schedule, presentation candidate, task priorities).
Output: prompt sentence text for generating a natural-language notification.

### Step 12:

Server generates a natural-language notification message using the generative AI model.

Server sends the response-generation prompt sentence to the generative AI model through the analysis interface. The generative AI model processes the prompt sentence and produces an output sequence that forms a natural-language message tailored to the specific structured data. Server receives this output text, optionally performs post-processing such as trimming or inserting links to schedule entries, documents, or tasks, and finalizes the notification message.
Input: response-generation prompt sentence.
Output: natural-language notification message ready to be delivered to the user.

### Step 13:

Server transmits the notification message to the terminal.

Server uses the communication unit to send the natural-language notification message back to the terminal via the communication network. Server embeds the message text and relevant metadata, such as conversation ID or user ID, in a response payload according to the communication protocol used by the terminal's application.
Input: natural-language notification message and delivery metadata.
Output: network response containing the notification message delivered to the terminal.

### Step 14:

Terminal displays the notification and provides access to linked resources.

Terminal receives the notification message from the server and renders the text in the user interface of the communication application. Terminal may also display hyperlinks or buttons that, when activated by the user, open scheduled events in a calendar application, open documents in a viewer, or show tasks in a task management client.
Input: notification message payload received from the server.
Output: visual and interactive presentation of the notification and associated resources on the terminal screen.

### Step 15:

User reviews the results and optionally issues follow-up utterances.

User reads the notification on the terminal and confirms the automatically scheduled meeting, the selected document, or the prioritized task list. User may decide to adjust or refine the result by inputting another natural-language utterance, such as requesting a different meeting time or asking to see an earlier version of a document. Such follow-up utterances become new inputs to the processing pipeline, causing the server to repeat Steps 2 and subsequent steps as appropriate.
Input: displayed notification and any user intent to modify or refine the result.
Output: new utterance data initiated by the user that triggers another processing cycle.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional voice-driven task automation systems in industrial and office environments typically implement a fixed set of rule-based mappings from user commands to system operations. In such systems, a processor generally performs straightforward speech-to-text conversion and then applies predetermined pattern matching or keyword rules to trigger tasks. This architecture suffers from several technical limitations.

First, the processor is required to maintain large, manually curated rule sets and grammars to cover various phrasing styles, domain-specific terminology, and contextual variations in user utterances. As the number of possible commands and workflows increases, the complexity of these rule sets grows non-linearly, resulting in increased memory consumption, deteriorated maintainability, and slower command interpretation. Modifying or extending the system to support new work procedures or additional equipment often requires extensive reprogramming and redeployment of software.

Second, conventional systems typically treat speech recognition and task interpretation as isolated stages, without deeply integrating contextual information such as work environment status, inventory state, or ongoing task schedules. As a result, even if the speech recognition stage correctly outputs a text representation of the user's utterance, the subsequent interpretation stage may fail to infer the correct task parameters, such as which process is “next,” which parts are relevant, or which tasks should be reprioritized. This leads to frequent misinterpretation, increased user corrections, and inefficient use of computing resources.

Third, existing platforms generally do not use a unified representation of user intent that can be directly consumed by downstream modules such as robot controllers, inventory databases, and scheduling services. Conventional systems often rely on ad hoc adapters between natural language commands and each subsystem, resulting in duplicated logic, inconsistent behavior, and increased latency as data passes through multiple translation layers.

Fourth, many systems treat emotional aspects of user speech, such as urgency and frustration, as non-technical “user experience” parameters and do not technically integrate emotion recognition into the core scheduling and prioritization mechanisms. Consequently, the processor is unable to dynamically adjust task priorities or resource allocation in real time based on emotionally expressed urgency in the voice input, which can lead to suboptimal sequencing of operations and delays in time-critical processes.

Fifth, with respect to inventory operations and physical work, conventional systems mostly separate informational responses from physical control. For example, a system might confirm that parts are available in a database but does not automatically trigger robot-based picking or update the inventory state in response to completed robot operations. This lack of tight integration among speech understanding, intent interpretation, machine control, and inventory updates requires human intervention, increases the number of message exchanges, and can cause inconsistencies between logical inventory records and physical stock.

Sixth, in schedule management and information retrieval, current systems often treat natural language requests as simple queries mapped to calendar or search APIs, without leveraging a generative model to generate structured task commands and coordinated schedules. As a result, the system cannot consistently produce optimized, machine-readable task schedules and cross-module workflows (e.g., linking picking tasks, inventory checks, and meetings) directly from natural language inputs.

Accordingly, there is a need for an improved computer-implemented system that: (i) uses a generative AI model in combination with prompt sentences containing both recognized text and situational information, (ii) produces structured command data that directly drives heterogeneous subsystems, including robot equipment and inventory databases, (iii) integrates emotion recognition into task prioritization at the processor level, and (iv) automatically executes and coordinates physical work, inventory management, schedule management, and information retrieval with reduced rule complexity, reduced translation layers, and improved responsiveness. Such a system would technically improve the functioning of the computer by transforming unstructured voice input into a unified, structured control layer, optimizing internal data flows and processing logic, and reducing computational overhead associated with rule-based parsing and manual integration.

The specific processing by the specific processing unit 290 of the data processing device 12 in Application Example 1 is realized by the following means.

The present invention provides a server comprising a processor and a communication interface, the processor being configured to receive, via a terminal, voice utterances from a user and convert the voice utterances into character string data by using a speech recognition unit; to generate, in memory, a prompt sentence that includes the character string data and situation information relating to a work environment; to input the prompt sentence to a generative AI model executed locally or accessed via a network; to obtain, from the generative AI model, structured command data representing an intention of the user; to generate, on the basis of the structured command data, control command data for controlling one or more devices including at least a work processing device, a work apparatus, or a mobile apparatus; to transmit, via the communication interface, the control command data to the one or more devices so as to automatically complete a physical work operation or an information processing operation; to execute an inquiry process to an information storage device that stores inventory information on the basis of the structured command data, to acquire and update the inventory information in response to results of the physical work operation, and to maintain consistency between logical inventory records and actual stock states; to recognize an emotion of the user from the voice utterances by performing emotion analysis on acoustic features and/or the character string data; to assign priorities to a plurality of tasks generated on the basis of the structured command data and the inventory information by taking into account importance, urgency, and the recognized emotion; to generate task management data for displaying, on the terminal, task lists sorted according to the assigned priorities; and to determine whether content of the voice utterances relates to at least one of schedule management, information retrieval, and inventory management, and, when it is determined that the content relates to at least one of the schedule management, the information retrieval, and the inventory management, to generate, on the basis of an output of the generative AI model, at least one of schedule data, retrieval result data, and inventory report data, to register or update the schedule data in a schedule management device, and to present the schedule data, the retrieval result data, or the inventory report data to the terminal. This enables the computer system to transform unstructured voice inputs into unified structured command data that directly drives heterogeneous subsystems, reduces reliance on static rule-based parsing, integrates emotion-aware task prioritization into the processor's scheduling logic, and technically improves internal resource utilization, responsiveness, and coordination among speech recognition, generative intent interpretation, device control, inventory management, schedule management, and information retrieval.

The term “processor” refers to a hardware and/or software computation unit that executes instructions, performs data processing operations, and controls other components of the system, including servers, terminals, and connected devices.
The term “terminal” refers to an information processing device, such as a portable device, a workstation, or a display-equipped input/output unit, that acquires user input including voice utterances and presents output information to a user.
The term “voice utterance” refers to an acoustic signal generated by speech of a user and captured by a microphone or equivalent audio input device.
The term “speech recognition unit” refers to a hardware circuit, software module, or combination thereof that converts a voice utterance from an analog or digital audio signal into character string data representing recognized text.
The term “character string data” refers to digital data representing text, including sequences of characters, symbols, or tokens obtained by processing a voice utterance.
The term “situation information” refers to data describing a current or relevant context of a work environment, including at least process information, task status, equipment status, schedule information, and inventory information.
The term “prompt sentence” refers to a text sequence or structured text input that includes at least character string data representing a user utterance and situation information, and that is provided as input to a generative AI model.
The term “generative AI model” refers to a machine-learned model, such as a neural network-based language model, that generates output data, including natural language text or structured data, in response to an input such as a prompt sentence.
The term “structured command data” refers to machine-readable data, such as a structured record or object, that explicitly represents an interpreted intention of a user, including at least an action type, parameters, and target resources.
The term “work environment” refers to a physical or virtual environment in which tasks are executed, including factory sites, warehouses, offices, and associated information systems.
The term “control command data” refers to data that specifies operations to be executed by a work processing device, work apparatus, or mobile apparatus, including instructions for motion, processing, communication, or status changes.
The term “work processing device” refers to an information processing unit or control device that manages or executes work-related processes, including controllers, servers, and industrial control systems.
The term “work apparatus” refers to a physical machine or equipment that performs work, such as industrial machinery, actuators, manipulators, or production equipment.
The term “mobile apparatus” refers to a movable device that changes its position within a work environment, including mobile robots, automated guided vehicles, and other autonomous or semi-autonomous transport devices.
The term “physical work operation” refers to an operation that involves movement or manipulation of physical objects or equipment, including at least picking, placing, conveying, assembling, or inspecting items.
The term “information processing operation” refers to an operation that manipulates, stores, retrieves, or analyzes data within one or more information processing devices.
The term “information storage device” refers to a memory component or storage system, such as a database, file system, or storage medium, that stores information including inventory information, process information, and schedule information.
The term “inventory information” refers to data representing stock states of one or more items, including item identifiers, quantities, locations, and threshold values such as safety stock levels.
The term “inquiry process” refers to a sequence of operations in which the processor accesses an information storage device to read, search, or retrieve data based on one or more conditions.
The term “update” refers to a modification of stored data, including writing, rewriting, or deleting records in an information storage device to reflect a current state of a system or environment.
The term “emotion” refers to a state inferred from characteristics of a user's voice utterance or text, such as urgency, frustration, satisfaction, or calmness, which can be recognized by analyzing acoustic features and/or character string data.
The term “task” refers to a unit of work to be executed by a device, a system, or a user, and may include associated attributes such as type, deadline, required resources, and priority.
The term “task management data” refers to structured data that represents one or more tasks, their attributes, and their priorities, and that is used to display and control execution order on a terminal.
The term “priority” refers to an attribute of a task that indicates an order of execution or relative importance, determined on the basis of at least importance, urgency, and recognized emotion.
The term “schedule management” refers to a process of creating, modifying, or maintaining time allocations and temporal relationships among tasks, events, or operations.
The term “information retrieval” refers to a process of searching, filtering, or selecting data or documents relevant to a query or request, and providing results to a user or system.
The term “inventory management” refers to a process of monitoring, updating, and controlling inventory information, including stock levels, locations, and replenishment conditions.
The term “schedule data” refers to structured data that represents dates, times, durations, and associations between tasks or events and corresponding time slots.
The term “retrieval result data” refers to structured data that represents outcomes of information retrieval, including identifiers, summaries, and relevance indicators of retrieved items.
The term “inventory report data” refers to data that summarizes inventory information for presentation, including current stock levels, shortages, and changes resulting from operations.
The term “robot apparatus” refers to a programmable machine capable of autonomous or semi-autonomous operation, including industrial robots, manipulators, and automated guided robots used for tasks such as picking or conveying.
The term “process information” refers to data pertaining to steps, sequences, or parameters of work processes, including process identifiers, process order, and associated required resources.
The term “component information” refers to data that identifies items, parts, or materials used in a work process, including part identifiers, names, quantities, and storage locations.
The term “picking process” refers to an operation in which specific items or components are selected and retrieved from storage locations in accordance with process information and component information.
The term “schedule management device” refers to a hardware and/or software system that stores, manages, and provides access to schedule data, including internal scheduling modules and external calendar or scheduling services.

In one embodiment, a server, a terminal, and a user cooperate to implement the invention. The server comprises at least one processor, a memory, a communication interface, and access to an information storage device such as a relational database system. The terminal comprises at least one processor, a microphone, a display unit, a network interface, and a local memory. The user operates the terminal by issuing voice utterances.

The terminal uses hardware such as a built-in microphone and audio codec, and software such as an operating system audio stack (for example, an audio capture API corresponding to Android AudioRecord or an equivalent component in another platform) to acquire an analog voice signal from the user and convert the voice signal into digital audio samples. The terminal stores the digital audio samples in a buffer in its local memory and may compress the samples into a standardized audio format such as linear pulse-code modulation or lossless compressed audio. The terminal then uses a network communication library (for example, an HTTP client library) to transmit the buffered audio data to the server via an IP-based network.

The server uses a speech recognition unit to convert received audio into character string data. In one embodiment, the speech recognition unit is implemented as a deep neural network model hosted on a remote speech recognition service. The server packages the digital audio samples and recognition parameters into a request and transmits the request via the communication interface to the speech recognition service. The speech recognition service applies an acoustic model and a language model to generate a recognition result in the form of text. The acoustic model may be implemented as a convolutional neural network or recurrent neural network operating over time-frequency features such as Mel-frequency cepstral coefficients. The language model may be implemented as a recurrent neural network or a transformer model that predicts sequences of characters or subword tokens. The server receives the recognition result and stores the resulting character string data in the memory.

The server then generates a prompt sentence that combines the character string data and situation information related to a work environment. The server maintains situation information in the information storage device, for example in tables of a relational database management system such as a general-purpose SQL database. The situation information can include process identifiers, task identifiers, equipment status codes, inventory item identifiers, stock quantities, and scheduled time slots. The server retrieves relevant situation information by issuing structured queries to the database and then concatenates the retrieved information with the recognized text into a single prompt sentence or a sequence of prompt sentences.

In one example, the user issues a voice utterance equivalent to “Pick up the parts needed for the next process.” The speech recognition unit outputs corresponding character string data.

The server then constructs a prompt sentence such as:
“You are a factory operation assistant. Interpret the following user request and output a JSON-like command describing an action and parameters. Available actions include: PICK_PARTS, CHECK_INVENTORY, ADJUST_SCHEDULE, SEARCH_DOCUMENT.

The current process context is: next process is Assembly-Line-A, which requires specific component identifiers and quantities stored in the process database. User said: ‘Pick up the parts needed for the next process.’”

In another example, when the user issues a voice utterance equivalent to “Check the inventory,” the server generates a prompt sentence such as:
“You are an inventory control assistant. Interpret the following user request and output a structured command for inventory inspection. The inventory table contains item identifiers, current stock values, and safety stock thresholds. User said: ‘Check the inventory.’”

In a further example, when the user issues a voice utterance equivalent to “Adjust today's work schedule,” the server generates a prompt sentence such as:
“You are a scheduling assistant. The current task list includes multiple tasks with associated deadlines and priorities. Rearrange tasks to optimize completion before deadlines. User said:
‘Adjust today's work schedule.’ Output a structured schedule description.”

The server inputs the generated prompt sentence into a generative AI model. In one embodiment, the generative AI model is a transformer-based neural network language model having an encoder-decoder or decoder-only architecture. The generative AI model is parameterized by a weight matrix set trained in advance on large amounts of text data and domain-specific command formats. The server accesses the generative AI model via an application programming interface of a model hosting service, or the server executes the model locally by loading model parameters into memory and performing forward inference using linear algebra libraries that exploit vectorized instructions and hardware acceleration such as graphics processing units.

The generative AI model processes the prompt sentence by converting input tokens into vector embeddings, propagating the embeddings through multiple layers of self-attention and feed-forward sublayers, and computing an output token sequence that encodes structured command data. The model uses an attention mechanism to weight contributions from different parts of the prompt sentence, including both user text and situation information. The model generates a representation that expresses an action type, arguments such as item identifiers or task identifiers, and parameters such as quantities and time ranges.

The server parses the output of the generative AI model into structured command data, for example in an internal object format that includes fields such as an action field, parameter fields, and target device fields. The structured command data is then used by separate modules in the server to control different subsystems. The server does not rely on static keyword rules; instead, the server uses the generative AI model output as a semantic interpretation layer that compresses a wide variety of possible user utterances and context combinations into a relatively small set of action types and parameters. This reduces branching complexity in program logic and reduces memory needed for rule sets.

The server uses the structured command data to generate control command data for a work processing device, a work apparatus, or a mobile apparatus. In one embodiment, the work apparatus is a robot apparatus such as an articulated manipulator or an automated guided vehicle. The server maintains mapping data from logical item identifiers and locations to physical coordinates within a facility. The server applies a planning algorithm that maps requested picking actions to robot motion commands. For example, the server converts part identifiers into storage coordinates using look-up tables stored in the database, then computes a sequence of robot joint targets or path waypoints. The server encodes these into control messages using a robotics middleware protocol, such as a message format defined in a robot control software framework or an industrial control protocol. By directly generating such control command data from the structured command data, the server reduces translation layers between natural language interpretation and device-level control.

The server also interfaces with an information storage device that holds inventory information. When the structured command data specifies an inventory check or a change to inventory quantities, the server constructs and executes queries against an inventory table. For example, the inventory table may include columns for item identifiers, current quantity values, safety stock threshold values, storage location codes, and last update timestamps. The server uses indexing structures such as B-tree indexes on the item identifier field to accelerate retrieval. The server updates inventory quantities when the robot apparatus reports completion of a picking operation. To maintain consistency, the server uses transaction control in the database to atomically apply updates and commit them together with log entries.

The server implements an emotion recognition module to infer emotion from the voice utterance. In one embodiment, the server extracts acoustic features from the audio signal, such as Mel-frequency cepstral coefficients, pitch contours, energy features, and temporal statistics. The server feeds these features into a separate neural network, such as a recurrent or convolutional network trained on labeled emotion data. The network outputs one or more emotion categories or a continuous value indicating urgency or stress. The server can also analyze the character string data with a text classifier to identify linguistic expressions of urgency or importance, and then combine acoustic and textual scores.

The server generates task management data based on structured command data, inventory information, and recognized emotion. The server represents tasks in a data structure that includes attributes such as a unique task identifier, an action type, a required resource, an estimated duration, a due time, and a priority score. The server calculates a priority score using a function that combines importance, urgency, and emotion-derived weights. For example, the server may compute a numeric priority as a weighted sum of normalized due-time proximity, estimated impact on other tasks, and recognized urgency in the user's voice. The server sorts the tasks according to the priority score and generates a list or schedule that can be stored and transmitted to the terminal.

The terminal receives task management data and displays task lists or schedules on the display unit. The terminal renders visual representations such as ordered lists, color-coded priority indicators, and time-line views using a graphical user interface framework. The user can view upcoming tasks and their relative priorities. When the user issues new voice utterances, the server updates the task management data and the terminal reflects the updated priorities, thereby enabling dynamic, emotion-aware scheduling.

In the case of schedule management, the server interprets structured command data that indicates a request to adjust or create schedules. The server interfaces with an internal or external schedule management device, such as a calendar service or scheduling module. The server converts task descriptors into scheduled events, assigning start and end times based on availability and task dependencies. The server may use constraint-based scheduling algorithms or heuristic algorithms to avoid conflicts and to optimize resource usage. The server registers or updates schedule data via an application programming interface of the schedule management device and then notifies the terminal of the updated schedule.

In the case of information retrieval, the server interprets structured command data specifying a search action. The server queries an information storage device that may include a document repository or knowledge base. The server may use full-text search indexes or vector similarity search based on document embeddings. The generative AI model helps transform ambiguous user utterances into explicit search intents, including domain-specific terms and restrictions, resulting in more precise retrieval and reduced need for manual query formulation by the user.

From a technical perspective, the use of a generative AI model and prompt sentences in this system yields improvements in computer operation beyond simple automation of human activities. The server reduces reliance on large, hand-coded rule sets and instead encodes interpretation complexity within a trained neural network that can handle varied phrasings and contexts. This reduces the amount of deterministic branching and pattern matching code executed by the processor and thereby reduces instruction cache pressure and improves processing throughput. Because the generative AI model generates structured command data directly from natural language and context, the number of intermediate transformation steps and data marshaling operations is reduced, which lowers latency between user utterance and device actuation.

The server also achieves improved accuracy in mapping user intentions to device-level operations by integrating situation information into the prompt sentence. The prompt sentence explicitly includes process identifiers, inventory states, and task statuses, allowing the generative AI model to condition its output on the current system state. This reduces errors due to ambiguous utterances such as “the next process” or “those parts.” By reducing misinterpretations, the server reduces rollback operations and corrective re-executions, improving overall computational efficiency.

In addition, the emotion recognition module enables the processor to adjust scheduling and prioritization in a way that cannot be achieved by static rules alone. The server dynamically modifies internal priority values in the task management data based on recognized emotional urgency, which is based on measurable acoustic features and text features. This allows the processor to allocate computation and communication resources preferentially to high-urgency tasks, thereby improving responsiveness and reducing perceived delay for time-critical operations.

The generative AI model itself may be implemented as a multi-layer transformer network with self-attention heads, trained using a supervised or semi-supervised learning method. The server uses a training process that minimizes a loss function such as cross-entropy between predicted tokens and ground truth tokens on training corpora that include command descriptions and structured outputs. During training, the server applies an optimization algorithm such as stochastic gradient descent with adaptive moment estimation to update model weights. The server can apply data augmentation techniques, such as paraphrasing of commands or random masking of context tokens, to improve robustness. Once trained, the model is deployed and loaded into memory for inference. During inference, the server uses techniques such as beam search or nucleus sampling to generate outputs with controlled variability.

By structuring commands as explicit action-parameter pairs and using uniform data structures, the server also simplifies the integration of robotic control and inventory databases. Instead of separate, custom parsers for each subsystem, the server uses a unified representation that downstream modules can consume through well-defined interfaces. This reduces duplication of logic and potential inconsistencies. The server's database access layer uses prepared statements and standardized schemas, improving cache locality and query planning. The server can therefore execute more queries per unit of time and serve more concurrent users without linear expansion of hardware resources.

In alternative embodiments, the generative AI model may be executed partially on the terminal for latency-sensitive tasks, with a smaller model running locally and a larger model running on the server. The terminal can perform preliminary intent classification or extraction of key slots, while the server performs full interpretation and device control. In other embodiments, the speech recognition unit runs on the terminal and sends only character string data to the server, thereby reducing network bandwidth usage.

In another embodiment, the server uses a different type of neural architecture for the generative AI model, such as an encoder-decoder model with attention, where the encoder processes the prompt sentence and the decoder generates structured command text. In yet another embodiment, the server uses a hybrid approach where the generative AI model outputs candidate interpretations and a rule-based post-processor selects among them based on consistency with database constraints or device capabilities. This combination further improves reliability and reduces spurious interpretations.

In still another embodiment, the server controls multiple types of work apparatus and mobile apparatus, such as conveyor controllers, lift mechanisms, and autonomous vehicles. The structured command data includes a target device type field, and the server maintains mapping tables to route control command data to the correct device. The server's control to the devices uses different communication protocols depending on device type, such as a fieldbus-based protocol or a message-based robot middleware.

Across these embodiments, the system's architecture focuses on specific data structures (character string data, prompt sentences, structured command data, control command data, inventory records, and task management data) and defined operations on these structures. The integration of speech recognition, generative AI interpretation, emotion recognition, database operations, and device control in a unified flow provides a concrete technical solution that improves processing speed, accuracy, and resource usage compared to conventional rule-based systems, and thereby supports practical implementation of the claimed invention in real-world environments.

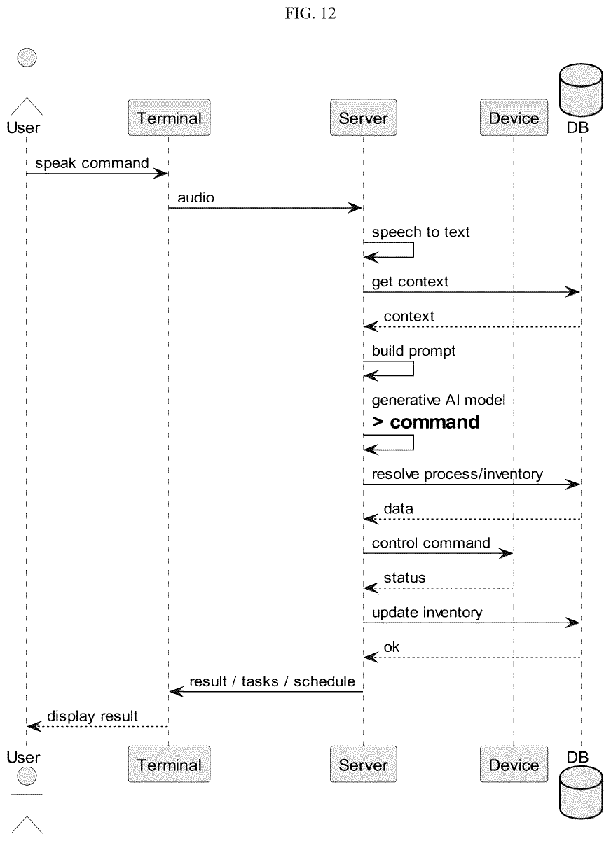

The following describes the processing flow using FIG. 12.

### Step 1:

User issues a voice utterance.

User speaks a command toward the terminal, for example “Pick up the parts needed for the next process” or “Check the inventory.”
Input: No digital input; the input is the user's spoken voice in the air.
Output: An analog acoustic signal reaching the microphone of the terminal.

### Step 2:

Terminal acquires and digitizes the voice.

Terminal uses its microphone and audio codec to capture the analog acoustic signal and convert it into digital audio samples (for example, 16-bit PCM at 16 kHz). Terminal stores the samples in an in-memory buffer and may segment the stream into fixed-length frames.
Input: Analog acoustic signal from the user.
Output: Buffered digital audio data representing the user's utterance.

### Step 3:

Terminal encodes audio and sends it to the server.

Terminal optionally compresses the buffered digital audio data into a specific audio format (for example, linear PCM or lossless compressed frames) and attaches metadata such as sampling rate and language code. Terminal then creates an HTTP or similar network request and transmits the encoded audio data to the server via a network interface.
Input: Buffered digital audio data and associated metadata.
Output: A network message containing the encoded audio payload and metadata delivered to the server.

### Step 4:

Server receives audio and performs preliminary validation.

Server accepts the incoming network request through a communication interface, reads the audio payload into server memory, and validates parameters such as authentication token, content type, and audio length. Server may reject malformed or unauthorized requests and log errors.
Input: Network message containing encoded audio and metadata.
Output: Validated digital audio data stored in server memory, or an error response if validation fails.

### Step 5:

Server converts speech to character string data.

Server sends the validated digital audio data to a speech recognition unit, either a local module or a remote recognition service. The speech recognition unit computes acoustic features (for example, Mel-frequency cepstral coefficients), applies a trained acoustic model and language model, and decodes the most probable sequence of tokens.
Input: Digital audio data and recognition parameters (for example, language setting).
Output: Character string data representing the recognized text of the user's utterance (for example, “Pick up the parts needed for the next process”).

### Step 6:

Server acquires situation information from storage.

Server queries an information storage device, such as a relational database, to retrieve context data related to the current work environment, including process identifiers, inventory states, and ongoing tasks. Server executes database queries using keys such as user identifier, terminal identifier, or current process code.
Input: Character string data, current session information, and database state.
Output: Situation information records (for example, next process ID, required component list, current inventory levels) loaded into memory.

### Step 7:

Server generates a prompt sentence for the generative AI model.

Server combines the character string data and the situation information into a structured textual description. Server formats this description as a prompt sentence that clearly specifies available actions and relevant context. Server may insert delimiters or headings to separate user speech and context.
Input: Character string data and situation information.
Output: A prompt sentence text, for example:
“You are a factory operation assistant. Interpret the following user request and output a command describing an action and parameters. Available actions include: PICK_PARTS, CHECK_INVENTORY, ADJUST_SCHEDULE, SEARCH_DOCUMENT. The current process context is: next process is Assembly-Line-A, which requires specific components.
User said: ‘Pick up the parts needed for the next process.’”

### Step 8:

Server sends the prompt sentence to the generative AI model and obtains structured command data.

Server tokenizes the prompt sentence, transmits it to a generative AI model (for example, a transformer-based language model) via an API or local inference engine, and triggers forward inference. The generative AI model performs embedding, self-attention, and feed-forward computations to generate an output token sequence that encodes a structured command.

Server then detokenizes and parses the output into a machine-readable structure.
Input: Prompt sentence text.
Output: Structured command data, containing fields such as action type (for example, PICK_PARTS), parameters (for example, process ID, item identifiers, quantities), and optional flags.

### Step 9:

Server resolves abstract intent into concrete process and inventory parameters.

Server examines the structured command data and, when necessary, queries the process database and inventory database to resolve abstract references (for example, “next process,” “needed parts”) into specific process IDs, item IDs, and quantities. Server runs database joins and lookups using process tables, bill-of-materials tables, and inventory tables.
Input: Structured command data and database records for processes and inventory.
Output: Enriched command data with concrete identifiers, quantities, and storage locations suitable for device control and inventory operations.

### Step 10:

Server generates control command data for devices.

Server maps the enriched command data to device-specific control formats. For a picking action, server converts item identifiers and storage locations into robot coordinates or conveyor routing parameters using mapping tables and coordinate transformation algorithms.

Server then assembles control command messages that include motion commands, speed settings, and operation sequences.
Input: Enriched command data (for example, item IDs, rack positions, quantities).
Output: Device control command data formatted for a work processing device, work apparatus, or mobile apparatus.

### Step 11:

Server transmits control command data to devices and monitors execution.

Server sends the control command data through a device communication interface using industrial protocols or robot middleware. Server receives status messages from devices indicating progress, completion, or errors. Server updates internal task status records accordingly.
Input: Control command data and current device state.
Output: Device status information (for example, success, failure, partial completion) stored in server task records.

### Step 12:

Server executes inventory inquiry and update operations.

Server uses the enriched command data and device status results to construct SQL queries or equivalent database operations. For an inventory check, server performs SELECT operations to retrieve relevant stock levels and safety thresholds. For a completed picking operation, server performs UPDATE operations to decrement quantities and log transaction records.
Input: Enriched command data, device status information, and current inventory table contents.
Output: Updated inventory information and retrieved inventory records reflecting current stock state.

### Step 13:

Server performs emotion recognition and priority computation.

Server analyzes the original audio signal and/or character string data to extract emotion indicators. Server computes acoustic features (for example, pitch, volume, speech rate) and textual features (for example, urgency keywords) and inputs these features into an emotion classification module. The module outputs an emotion label or urgency score. Server then calculates a priority value for each task using a mathematical function that combines importance (for example, from process rules), urgency (for example, from deadlines), and emotion-derived scores.
Input: Audio features, character string data, process rules, and existing task list.
Output: Updated task records with computed priority values and associated emotion indicators.

### Step 14:

Server generates task management data and schedules.

Server sorts tasks according to priority values and, when applicable, assigns time slots based on device availability and existing schedules. Server bundles the sorted tasks and scheduling information into task management data structures. Server may also create or update entries in a schedule management device by calling its API with start times, end times, and task identifiers.
Input: Task records with priorities, device calendars, and schedule management device state.
Output: Task management data including ordered task lists and schedule data linked to each task.

### Step 15:

Server determines response content and formats output messages.

Server examines the structured command data and processing results (device status, inventory updates, schedule changes) to decide which information to return to the terminal. Server composes human-readable messages summarizing task execution, inventory status, or schedule updates and may also include structured data lists for display.
Input: Structured command data, execution results, updated inventory information, and task management data.
Output: Response payloads containing text messages and structured display data (for example, task lists, stock tables, schedule entries).

### Step 16:

Server sends the response to the terminal.

Server generates a network response containing the response payloads and transmits it via the communication interface to the terminal. Server may use HTTP responses, push notifications, or persistent connections, depending on system design.
Input: Response payloads prepared by the server.
Output: Network messages delivered to the terminal with messages and data for presentation.

### Step 17:

Terminal presents results to the user.

Terminal receives the network messages from the server, parses the payloads, and updates its user interface. Terminal renders text summaries (for example, “Picking completed for specified parts”), visual elements such as task lists and inventory tables, and schedule views.

Terminal may also play alert sounds or display icons to indicate high-priority tasks inferred from emotion recognition.
Input: Network messages containing messages, task management data, inventory records, and schedule data.
Output: Visual and/or audible outputs presented to the user, enabling the user to perceive execution results, current inventory state, and updated priorities or schedules.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional task automation and digital assistance systems rely on fixed rule sets or narrow intent classifiers to interpret user utterances and to trigger downstream processing such as scheduling, information retrieval, and task prioritization. Such systems typically process each user request in isolation, perform only shallow linguistic analysis, and map detected keywords to pre-defined operations. As a result, they suffer from several technical limitations.

First, existing systems have limited capability to robustly convert ambiguous and context-rich natural language utterances into fully specified, machine-executable commands. When users omit parameters such as exact dates, durations, participants, or search constraints, known systems either fail, request multiple clarification rounds, or apply simplistic defaults. This leads to frequent user interaction loops, redundant network traffic between terminals and servers, and increased processing overhead on server-side components that must repeatedly parse and re-interpret similar inputs.

Second, conventional architectures often separate natural language analysis from downstream business logic in a static manner. An initial intent classification result is directly consumed by scheduling, search, or task modules, without iterative refinement or normalization. In particular, existing systems do not systematically use generative models to transform intermediate analysis outputs into richer structured commands that can be consumed uniformly by heterogeneous processing modules. This results in ad hoc adapter code, duplicated parsing logic, and increased error propagation when the initial analysis is incomplete or noisy.

Third, current systems frequently process scheduling, information retrieval, and task prioritization as independent vertical functions, each with its own data model and logic, which leads to fragmented handling of user context. For example, a scheduling engine might not incorporate user emotional state or task urgency, and a task prioritization engine might not exploit contextual information embedded in prior utterances. This fragmented approach causes suboptimal resource utilization, redundant database queries, and difficulty in optimizing system-wide performance metrics such as latency and throughput.

Fourth, conventional task management systems typically compute task priority using fixed rules and static weightings, without dynamically incorporating user emotion or context derived from natural language interactions. Because such systems do not adapt their internal prioritization logic based on affective cues, they cannot efficiently align computational resources and scheduling decisions with the user's actual needs. This lack of adaptive prioritization can cause the server to spend resources on lower-impact operations, increasing queue lengths and delaying processing of truly urgent operations.

Fifth, existing user-facing response generation pipelines generally rely either on rigid templates or on a one-shot application of generative models to raw user input, without taking advantage of intermediate structured data generated by the system. As a result, known systems cannot consistently generate concise, accurate, and technically grounded natural language responses that reflect the exact state of system-executed tasks. This mismatch between internal state and user-visible explanations complicates error diagnosis, impedes effective logging and monitoring, and weakens the ability to debug or optimize the underlying computational workflows.

Accordingly, there is a need for a technical architecture that integrates external language analysis services and generative AI models into the core of the server-side processing pipeline, to (i) transform natural language utterances into extended structured commands with explicit parameters, (ii) coordinate heterogeneous processing modules such as schedule management, information search, and task management through a unified structured representation, (iii) compute and dynamically adjust task priorities based on both objective parameters and user emotion derived from utterances, and (iv) generate natural language responses grounded in structured execution results. Such an architecture should improve the efficiency and robustness of the server's computation, reduce redundant interactions and processing, and enhance the ability of the system to automatically complete complex tasks with minimal user input while maintaining predictable and auditable behavior.

The specific processing by the specific processing unit 290 of the data processing device 12 in Example 2 is realized by the following means.

The present invention provides a server comprising a processor and a memory storing instructions which, when executed by the processor, cause the processor to receive natural language utterances as text data from a terminal, transmit the text data to a language analysis component to obtain first structured analysis data including at least an intention, a target, time information, and participant information, generate a first prompt sentence based on the first structured analysis data, input the first prompt sentence to a generative AI model, receive extended structured data including at least a task type, task parameters, and complement information for missing items from the generative AI model, and select, based on the extended structured data, at least one processing module associated with at least one of a schedule management function, an information management function, and a task management function. This enables the server to convert ambiguous user utterances into explicit, machine-executable task specifications, allowing heterogeneous processing modules to operate on a unified, enriched command representation and thereby improving computational efficiency and robustness of downstream task execution.

The present invention provides a server comprising a processor and a memory storing instructions which, when executed by the processor, cause the processor to, for schedule management processing, acquire availability information of multiple users from a schedule storage resource, compute common available time periods that satisfy a predetermined time length, and generate schedule information by registering events in the computed common available time periods, and to, for information search processing, acquire candidate information from a document storage resource or an information retrieval resource, rank the candidate information based on at least the first structured analysis data and the extended structured data, and identify extracted information according to the ranking. This enables the server to perform computation-intensive operations such as multi-user free/busy intersection and relevance-based ranking using normalized structured parameters, thereby reducing redundant queries, lowering error rates in external service calls, and improving throughput in multi-user scheduling and information retrieval scenarios.

The present invention provides a server comprising a processor and a memory storing instructions which, when executed by the processor, cause the processor to, for task management processing, acquire task information from a task storage resource or an external task management service, compute, for each task, a priority score based on at least deadline information and importance information using a numerical scoring function, and generate a priority list in which tasks are ordered according to the computed priority scores, and to recognize an emotion of the user from the natural language utterance and adjust at least one of the computed priority scores and the selection of the processing module according to the recognized emotion. This enables the server to implement an adaptive prioritization engine that maps affective signals and objective constraints into numerical scores, optimizing allocation of computational resources to tasks that provide the highest impact for the user and thereby improving overall system responsiveness and utilization.

The present invention provides a server comprising a processor and a memory storing instructions which, when executed by the processor, cause the processor to generate a second prompt sentence based on structured data including at least one of a result of execution of a task, the extracted information, and the priority list, input the second prompt sentence to a generative AI model, receive a natural language explanation from the generative AI model, and transmit the natural language explanation to the terminal. This enables the server to generate user-facing messages that are directly grounded in internal structured state, improving traceability and debuggability of the system's behavior while reducing the complexity of template management and allowing efficient reuse of the structured execution data when generating explanations.

The present invention provides a server comprising a processor and a memory storing instructions which, when executed by the processor, cause the processor to integrate the above-described reception, analysis, structured transformation, module selection, task execution, priority computation, emotion adjustment, and explanation generation into a unified processing pipeline that is triggered by each user utterance and that maintains a consistent structured representation across components. This enables the server to realize an improved computer-implemented architecture in which sequential and conditional data flows are optimized, network calls to external analysis and management services are orchestrated based on enriched structured commands, and overall latency and error propagation across the pipeline are reduced, thereby improving the technical performance and reliability of the computer system implementing the digital assistant functionality.

The term “system” refers to a combination of hardware and software components including at least one processor and associated resources configured to execute the claimed functions.
The term “processor” refers to one or more hardware processing units, such as a central processing unit, a graphics processing unit, or another computing element, configured to execute instructions stored in a memory.
The term “terminal” refers to any user-operated electronic apparatus, including but not limited to a mobile device, a personal computer, or a client device, that transmits user input and receives output from the system.
The term “user” refers to a human operator or an entity that interacts with the system through the terminal by providing natural language utterances and receiving responses.
The term “natural language utterance” refers to text or speech content expressed in a human language and converted into text data for processing by the system.
The term “text data” refers to digital information representing characters or strings in a human language encoded in a machine-readable format.
The term “information exchange means” refers to any communication mechanism or service that enables the user to send and receive messages, including, for example, messaging platforms, electronic mail services, or chat interfaces.
The term “electronic communication means” refers to any network-based communication infrastructure or protocol, including, for example, the internet, a mobile network, or a local area network, that transports digital data between the terminal and the system.
The term “language analysis component” refers to a software component or external service configured to perform natural language processing on text data and to output analysis result data in a structured format.
The term “natural language processing apparatus” refers to a computing resource, either local or remote, that analyzes human language text using linguistic or statistical techniques to extract structured information such as entities and intent.
The term “analysis result data” refers to structured data generated by the language analysis component, including at least an intention, a target, time information, and participant information derived from the user's natural language utterance.
The term “intention” refers to a semantic representation of a purpose or action requested by the user, such as schedule management, information search, or task management.
The term “target” refers to an object or subject of the requested action, such as an event, a document, or a task, identified from the user's natural language utterance.
The term “time information” refers to temporal data elements extracted from the user's utterance, including, for example, dates, times, time ranges, or durations.
The term “participant information” refers to data identifying one or more entities, such as persons or groups, that are involved in a requested operation, for example as meeting attendees or task owners.
The term “structured data” refers to data organized into a defined schema, such as key-value pairs or objects, that can be programmatically consumed by processing modules.
The term “prompt sentence” refers to a text string constructed by the system and provided as input to a generative AI model to instruct or guide the model in producing a desired output.
The term “generative AI model” refers to a machine learning model configured to generate text or other content based on input data, including large-scale language models capable of producing natural language responses.
The term “extended structured data” refers to structured data produced by the generative AI model in response to a prompt sentence, including at least a task type, task parameters, and complement information for missing items.
The term “task type” refers to a classification of an operation to be performed by the system, such as a schedule management task, an information search task, or a task management task.
The term “task parameters” refers to specific values or constraints required to execute a task, including, for example, dates, durations, resource identifiers, or query terms.
The term “complement information” refers to additional parameter values or constraints generated to fill in missing or ambiguous items in the initial analysis result data.
The term “processing module” refers to a software component or functional unit configured to perform a specific category of processing, such as schedule management processing, information management processing, or task management processing.
The term “schedule management function” refers to a function that handles operations related to creating, updating, or querying events or appointments in schedule data.
The term “information management function” refers to a function that handles operations related to storing, retrieving, or organizing information resources such as documents or records.
The term “task management function” refers to a function that handles operations related to creating, updating, or prioritizing tasks associated with a user or a group.
The term “schedule storage device” refers to any storage resource, local or remote, that stores schedule information for one or more users, including, for example, a calendar database or a scheduling service.
The term “availability information” refers to data indicating time periods during which one or more users are free or busy according to their schedule information.
The term “common available time period” refers to a time interval during which all relevant users are available according to their respective availability information.
The term “schedule information” refers to structured data describing one or more scheduled events, including at least time information and participant information.
The term “information search task” refers to a task in which the system retrieves and ranks information resources based on conditions derived from the user's utterance and the extended structured data.
The term “document storage resource” refers to any storage resource that stores documents or files, such as a document repository, a data store, or a file management system.
The term “information retrieval resource” refers to a component or service configured to search and retrieve information based on query conditions, including, for example, a search engine or an index server.
The term “candidate information” refers to one or more information items retrieved from a document storage resource or an information retrieval resource prior to ranking or filtering.
The term “extracted information” refers to one or more items selected from candidate information according to ranking or filtering criteria based on the analysis result data and the extended structured data.
The term “task management task” refers to a task that involves processing task information, including determining priorities and organizing tasks for execution or presentation.
The term “task storage resource” refers to a storage resource or service that maintains task information, including attributes such as deadlines, importance, and status.
The term “external task management service” refers to a network-based service, separate from the system, that manages tasks and provides an interface for creating, updating, or querying tasks.
The term “task information” refers to structured data describing a task, including at least deadline information, importance information, and optionally status or owner information.
The term “deadline information” refers to temporal data indicating a due date or time by which a task is to be completed.
The term “importance information” refers to a value or attribute indicating the relative significance or priority level assigned to a task.
The term “priority score” refers to a numerical or ordered value computed from task information, including deadline information and importance information, used to determine the relative order of tasks.
The term “priority list” refers to an ordered list of tasks arranged according to corresponding priority scores.
The term “emotion” refers to an affective state of the user, such as urgency, stress, or satisfaction, inferred from the content or style of the user's natural language utterance.
The term “correction of the priority score” refers to an adjustment of a computed priority score based on additional factors, including the recognized emotion of the user.
The term “selection of the processing module” refers to a decision by the system to activate a particular processing module or combination of modules to handle a user's request based on structured data and contextual information.
The term “explanation sentence” refers to a natural language text generated by the generative AI model that describes at least one of a result of task execution, extracted information, or a priority list in a form understandable by the user.
The term “text datum in natural language” refers to a unit of digital text content expressed in a human language and suitable for presentation to a user via the terminal.
The term “time condition” refers to a constraint related to temporal aspects, such as creation time, modification time, or reference time period, used in filtering or ranking candidate information.
The term “creator condition” refers to a constraint specifying attributes of a creator or owner of information, such as a user identity or group, used in filtering or ranking candidate information.
The term “content condition” refers to a constraint specifying attributes of the content of information, such as keywords, topics, or document type, used in filtering or ranking candidate information.
The term “summary” refers to a condensed natural language representation of the main content of an information item generated for the purpose of efficient user review.
The term “explanation” refers to a natural language description that clarifies or interprets an information item, a task, or a system action for the user.
The term “external schedule management service” refers to a network-based schedule management system separate from the claimed system, which provides interfaces for accessing and modifying schedule information.
The term “information management apparatus” refers to a computing resource or service that stores, organizes, and provides access to information items, such as documents, messages, or records.
The term “search request” refers to a structured query or message sent from the system to an information management apparatus or external information management service to retrieve relevant information items.
The term “higher-ranked candidate information” refers to one or more candidate information items that occupy top positions in a ranked set of candidate information after evaluation according to specified conditions.

In one embodiment, a server implements the claimed system as a network-accessible application executed on one or more computing devices. The server includes at least one processor, a main memory, a non-volatile storage device, and a network interface coupled via a bus. The processor executes an operating system, such as a general-purpose server operating system, and one or more application programs implementing a natural language processing pipeline, scheduling management, information management, and task management. The server also communicates with a terminal operated by a user. The terminal is, for example, a smartphone, a tablet, or a personal computer, and executes a client application or a web browser to present a user interface, capture natural language utterances from the user, and display responses received from the server.

The server stores in the non-volatile storage device a set of program modules, including a request reception module, a language analysis interface module, a generative model interface module, a command normalization module, a scheduling module, an information retrieval module, a task prioritization module, an emotion analysis module, and a response generation module. The server also stores configuration data and schema definitions for structured data objects used in the system. The program modules and configuration data are loaded into the main memory at runtime and executed by the processor.

The server uses a network interface to communicate with external language analysis services and with a generative AI model. In one embodiment, the language analysis service is provided as a cloud-based natural language processing service, and the generative AI model is provided as a large-scale language model accessible via an application programming interface. The server encapsulates calls to these external components in the language analysis interface module and the generative model interface module, thereby allowing the rest of the system to operate on internal structured data objects instead of raw natural language strings. The server uses specific data structures to represent intermediate and final processing results. For example, the server represents a user utterance as a “UtteranceRecord” containing fields such as a user identifier, a channel identifier, a timestamp, and a text string. The server represents the first analysis output from the language analysis service as an “NLPResult” object including an intention label, a target label, normalized time information, participant information, and confidence scores. The server represents the extended structured data produced by the generative AI model as an “ExtendedCommand” object including a task type, a set of task parameters, and complement information for missing elements. The server also represents schedule entries, information items, and tasks as structured records with defined schemas, including identifiers, time attributes, resource references, and status indicators.

The server uses the language analysis interface module to send the text string of the UtteranceRecord to an external language analysis service. The server receives a response that has already been parsed into tokens, entities, and intent candidates. The server maps this response into the NLPResult object using a fixed schema. Because the server enforces a stable data schema, the down-stream modules can rely on a consistent representation regardless of the specific external service implementation. This design reduces the need for duplicative parsing logic in multiple modules and centralizes error handling and normalization.

The server uses the generative model interface module to further refine and extend the NLPResult. The server generates a prompt sentence that explicitly describes the fields required in the ExtendedCommand. For example, the server constructs a prompt sentence such as:
“You are a task scheduling assistant. Normalize the following user request into a structured command. User request: ‘Set up a one-hour meeting sometime this week when everyone on the team is available.’ Extract the following fields: intent, task_type, start_date, end_date, duration_minutes, participants_scope, language. Return the values for each field in a consistent textual format.”

The server inputs this prompt sentence and the relevant NLPResult fields to the generative AI model. The generative AI model is, in one embodiment, a transformer-based neural network comprising an embedding layer, a multi-layer self-attention mechanism, feed-forward layers, and a softmax output layer over a vocabulary of tokens. The model has been trained in advance on large corpora of natural language data using a next-token prediction objective, and optionally fine-tuned on task-oriented dialogue and command normalization datasets. During inference, the generative AI model operates with fixed parameters and does not update its weights. The server uses temperature and top-k/top-p parameters in decoding to control the determinism and variability of its outputs. Because the server constrains the output format in the prompt sentence and may apply post-processing rules to enforce a strict schema, the generative AI model effectively functions as a structured command generator rather than as an unconstrained text generator.

The server processes the output of the generative AI model by parsing it into an ExtendedCommand object. The ExtendedCommand object includes explicit fields for task_type (for example, “create_meeting,” “search_document,” or “prioritize_tasks”), start_date and end_date represented in a normalized date format, duration_minutes represented as an integer, participants_scope represented as a group descriptor, and additional flags or constraints. The command normalization module validates and, if necessary, adjusts the ExtendedCommand using deterministic rules, such as defaulting to a business day range if the time range is incomplete, or mapping participants_scope to a known group alias.

The server uses the ExtendedCommand to select a processing module. When the task_type indicates a scheduling operation, the server uses the scheduling module. The scheduling module reads the participants_scope and uses a directory database to resolve the group descriptor into a list of user identifiers and associated calendar accounts. The scheduling module then queries one or more schedule storage resources, such as calendar databases or external calendar services, to fetch availability information for each participant. The scheduling module represents each participant's availability as a set of non-overlapping intervals over a specified time range. To compute common available time periods, the scheduling module applies an interval intersection algorithm that merges and intersects the availability intervals across participants. The scheduling module then selects the earliest or otherwise optimal interval that satisfies the duration_minutes and any additional constraints, such as working hours or maximum meeting size.

This interval-based computation reduces the number of queries and conflict resolution steps compared to naive per-slot checking. The server aggregates and reduces the availability information in a compressed representation, which reduces memory usage and speeds up intersection operations. The server also caches intermediate results when multiple scheduling operations involve the same group of participants and overlapping time ranges, further reducing external service calls and network traffic.

The server uses the information retrieval module when the task_type indicates an information search operation. The information retrieval module constructs a query using task parameters such as query_text, time_filter, creator_filter, and content filter. The module submits the query to a document storage resource or an information retrieval resource that indexes documents. The server receives a list of candidate information items with associated relevance scores, creation times, creators, and other metadata. The server applies a ranking algorithm that integrates the external relevance score with additional signals derived from ExtendedCommand, such as proximity to the specified time range and match with the specified creator. The server then selects top-ranked items as extracted information. Because the server uses structured command fields like time_filter and creator_filter to pre-filter and re-rank the candidate set, the server can reduce the size of the candidate set that must be transmitted back to the terminal, which in turn reduces network bandwidth and client-side processing.

The server uses the task prioritization module when the task_type indicates a task management operation. The task prioritization module retrieves task information from a task storage resource or an external task management service. The module calculates a priority score for each task using a numerical function that combines deadline information and importance information, such as a weighted inversion of days until deadline plus a scaled importance rank. The server represents the priority scores as floating-point numbers and sorts the tasks accordingly to produce a priority list. The server then applies the emotion analysis module to the original UtteranceRecord to derive an emotion indicator, using either the external language analysis service or an internal classifier. For example, the emotion analysis module may use a neural network classifier trained on labeled sentiment and urgency data, which operates on token embeddings and outputs a distribution over emotion classes such as “neutral,” “stressed,” or “urgent.”

The server adjusts the priority scores or module selection based on the recognized emotion. For example, if the emotion analysis indicates a high urgency, the server may multiply the weight associated with near-deadline tasks or tasks labeled as critical. This emotional adjustment is applied numerically within the prioritization algorithm rather than simply changing the display order, so that internal scheduling and resource allocation logic can also respect the updated priorities. This design allows the server to optimize CPU and network usage by giving precedence to high-priority tasks in internal queues.

The server uses the response generation module to generate natural language outputs for presentation to the user. The response generation module constructs a second prompt sentence that describes the contents of the internal structured state and instructs the generative AI model to produce a concise explanation. For example, the server may generate a prompt sentence such as:

“You are a digital assistant. Based on the following structured result, generate one short, clear English message for the user. Result: meeting_title=‘Team Status Update’, start_time=‘2026 Mar. 10 10:00’, end_time=‘2026 Mar. 10 11:00’, participants=5 people. Do not add extra information.”

The server transmits this prompt sentence and relevant structured fields to the generative AI model via the generative model interface module. The generative AI model produces an explanation sentence, which the server then embeds into a response object along with identifiers, links, and metadata. The terminal receives this response and renders the explanation and any associated interactive elements on the user interface. Because the server uses structured data as the primary source for response generation, the resulting natural language messages remain consistent with the actual execution state, and the generative AI model is constrained to generate factual, verifiable descriptions.

The server benefits from this architecture by consolidating all natural language interpretation and command generation into a structured pipeline. By using a transformer-based generative AI model only at well-defined points (for example, ExtendedCommand generation and explanation generation) and by constraining its outputs through explicit prompt sentences and schema validation, the server reduces the risk of unpredictable behavior and improves the reproducibility of command generation. The server also reduces redundant processing because it reuses the same ExtendedCommand representation across multiple modules rather than reparsing raw text for each operation.

In another embodiment, the server deploys the generative AI model locally, for example as an inference engine executed on a dedicated accelerator or graphics processor. The server loads model weights from the non-volatile storage device into GPU memory and performs forward passes using a fixed computation graph. The server configures batching of multiple UtteranceRecords to compute outputs for multiple users concurrently. This batching improves hardware utilization and reduces per-request latency. The server may also use quantization (for example, 8-bit weights) and caching of key-value pairs in the transformer layers to further reduce inference time and memory consumption. These optimizations result in measurable improvements in processing speed and scalability compared to a baseline rules-based or purely external-service-based system.

In yet another embodiment, the server uses data augmentation and fine-tuning techniques to improve the performance of the generative AI model on the specific task of command normalization. For example, the server may generate synthetic training pairs of user utterances and ExtendedCommand fields by perturbing dates, participants, and task descriptions in a controlled way. The server uses a supervised learning procedure with a cross-entropy loss function to adjust model weights on a subset of parameters, using gradient descent and backpropagation. The server then freezes the fine-tuned model and deploys it in inference mode. By aligning the model's predictions with the exact schema used by the system, the server improves the accuracy of parameter extraction and reduces the number of follow-up interactions required to correct misinterpretations.

The server provides multiple alternative implementations of the language analysis component. In one variation, the server uses an external natural language processing service only for basic tasks such as tokenization and part-of-speech tagging, while performing intent classification and entity extraction with its own internal neural network models. In another variation, the server uses a combination of rule-based patterns and machine-learned classifiers. For example, the server may define regular expression patterns to detect explicit date expressions and then apply a neural sequence labeling model to identify participants and task descriptions. These alternatives are integrated into the same pipeline via the unified NLPResult and ExtendedCommand schemas.

The server also provides alternative configurations of the scheduling, information retrieval, and task prioritization modules. In one variation, the scheduling module uses a heuristic that minimizes fragmentation of participants' free time rather than simply selecting the earliest available slot. In another variation, the information retrieval module uses a learning-to-rank algorithm that combines textual similarity features, recency features, and user-specific interaction history. In a further variation, the task prioritization module uses a non-linear scoring function or a small neural network to map task attributes and emotion features into a priority score. In each case, the server uses explicit numerical procedures and data structures to compute these results, providing a concrete technical contribution beyond mere automation of human judgment.

Because the server transforms unstructured natural language utterances into a unified structured representation and uses that representation to drive optimized computational modules for scheduling, search, and prioritization, the system achieves several technical effects. The server reduces the number of network round-trips by minimizing the need for clarification queries, thereby reducing communication load. The server reduces CPU time for parsing and interpreting user inputs by centralizing the language analysis and generative command generation in specialized modules, which can be optimized independently. The server improves accuracy in interpretation and execution by leveraging learned patterns in the generative AI model together with deterministic validation rules. The server improves data management by enforcing consistent schemas for internal state and by grounding all operations in these schemas. Through these mechanisms, the server does not merely automate human decision-making but rather implements an improved computer-based architecture that optimizes data flows, computation patterns, and resource usage in a way that could not be achieved by a purely manual or simplistic rule-based process.

The terminal cooperates with the server by capturing user utterances, transmitting text data to the server with minimal pre-processing, and presenting structured results and explanations. For example, the terminal may show an interactive list of suggested meeting times, each derived from the server's interval intersection computation, and allow the user to confirm or adjust a selection. The terminal may also display task lists ordered according to the priority scores computed by the server and updated dynamically based on emotion analysis. The user benefits from reduced cognitive load and from fast, consistent responses that reflect the server's optimized internal computation.

Through these embodiments, the invention provides practical, concrete mechanisms by which a server, terminal, and user interact, and by which the server's internal modules and data structures cooperate to implement the claimed system. The described configurations, algorithms, and data flows allow a person skilled in the art to implement and deploy the system on general-purpose or specialized computing hardware, while realizing the technical advantages in computation efficiency, accuracy, and resource utilization described above.

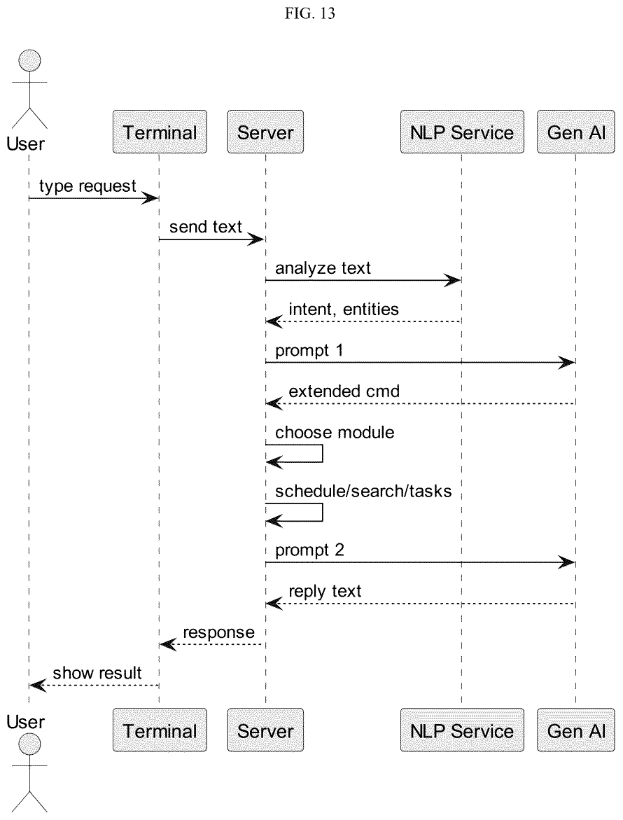

The following describes the processing flow using FIG. 13.

### Step 1:

User inputs a natural language utterance.

User operates the terminal and enters a natural language utterance such as “Set up a one-hour meeting sometime this week when everyone on the team is available” into a messaging interface or application.
Input: User's keystrokes or speech converted to a text string.
Output: A text string displayed in the terminal UI and passed to the terminal's client logic. Terminal captures the text from an input component, encodes it as UTF-8, and stores it in a temporary buffer. Terminal may attach metadata such as a user identifier and a timestamp.

### Step 2:

Terminal sends a structured request to the server.

Terminal generates a request object that includes fields such as user identifier, channel identifier, timestamp, and message_text.
Input: The text string and local metadata.
Output: A structured request (for example, JSON) sent over a network connection to the server.

Terminal uses an HTTP client or other network library to encapsulate the request object in an HTTPS POST message and transmits it to an endpoint exposed by the server.

### Step 3:

Server receives and validates the request.

Server accepts the HTTPS request via a network interface and passes it to a web application framework. Server decodes the request body and verifies authentication tokens.
Input: The structured request received from the terminal.
Output: An internal UtteranceRecord object containing the user identifier, timestamp, and text string, or an error status if validation fails.

Server parses the JSON, checks that required fields are present, and stores a log entry in a log storage for auditing and debugging.

### Step 4:

Server performs initial language analysis using an external service or internal NLP component.

Server extracts the text string from the UtteranceRecord and sends it to a language analysis component that performs tokenization, entity extraction, and intent detection.
Input: The UtteranceRecord containing the user's text.
Output: An NLPResult object that includes an intention label, a target label, time information, participant information, and confidence scores.

Server submits the text to the language analysis interface module, receives a response in a structured format, and maps the response fields into the schema of the NLPResult. Server may normalize time expressions (for example, “this week”) into specific date ranges and may map detected names into internal identifiers.

### Step 5:

Server constructs a first prompt sentence and calls the generative AI model for command extension.

Server uses the NLPResult to build a prompt sentence that explicitly specifies the required fields for an extended command.
Input: The NLPResult object and system configuration describing required ExtendedCommand fields.
Output: A text prompt sentence and an ExtendedCommand text response generated by the generative AI model.

Server concatenates instructions such as “Normalize this user request into a structured command” with the original utterance and the extracted entities, then sends this prompt sentence to the generative AI model. The generative AI model applies its transformer-based architecture to compute token probabilities, decodes a response that contains field values, and returns the response as text. Server receives this text and prepares it for parsing.

### Step 6:

Server parses the generative AI output into an ExtendedCommand object.

Server analyzes the text response from the generative AI model and extracts field values such as task_type, start_date, end_date, duration_minutes, and participants_scope.
Input: The ExtendedCommand text returned by the generative AI model.
Output: A validated ExtendedCommand object with explicit task parameters.

Server uses pattern matching and parsing rules to map text segments to specific fields, converts date strings to internal date-time objects, converts durations to integers, and verifies that mandatory fields are present. Server applies default rules when necessary, for example assigning a default meeting title if none is provided.

### Step 7:

Server selects an appropriate processing module based on the ExtendedCommand.

Server examines the task_type field and determines whether to invoke the scheduling module, the information retrieval module, or the task prioritization module.
Input: The ExtendedCommand object.
Output: A decision identifying one or more processing modules and a module-specific task descriptor.

Server reads the task_type and other parameters, constructs an internal task descriptor (for example, a scheduling task descriptor containing time range and participants_scope), and passes the descriptor to the chosen module. This selection reduces branching logic in later processing and standardizes how each module receives commands.

### Step 8:

Server executes scheduling processing when the task_type indicates meeting creation.

Server uses the scheduling module to compute common free time and to create a schedule entry.
Input: A scheduling task descriptor including start_date, end_date, duration_minutes, and participants_scope.
Output: A schedule result including one or more proposed meeting times and confirmed meeting details when a time is selected.

Server resolves participants_scope to a list of user identifiers using a directory database.

Server then queries schedule storage resources for each participant, receiving availability intervals. Server merges intervals and computes intersection segments that satisfy the duration_minutes value. Server selects an optimal segment according to a predetermined strategy, creates a schedule record with start and end times, and invokes a calendar interface to register the event in external or internal calendar systems.

### Step 9:

Server executes information search processing when the task_type indicates retrieval of documents or records.

Server uses the information retrieval module to search for relevant items in storage or indexed search systems.
Input: An information search task descriptor including query_text, time_filter, creator_filter, and content filter derived from the ExtendedCommand.
Output: A ranked list of extracted information items with metadata.

Server constructs a search query that combines full-text terms with filters on time and creator fields, sends it to a document or information retrieval resource, and receives a list of candidate items with relevance scores. Server applies additional ranking that adjusts scores based on closeness to the specified time range and degree of match to filters, and then selects the top-ranked items as extracted information.

### Step 10:

Server executes task prioritization processing when the task_type indicates task management.

Server uses the task prioritization module to compute numerical priority scores for tasks and generate a priority list.
Input: A task management descriptor indicating user identifier, desired time frame, and any special constraints from the ExtendedCommand.
Output: A priority list containing tasks ordered by priority score.

Server retrieves tasks from a task storage resource or an external task management service, each task having attributes such as deadline, importance, and status. Server computes a priority score for each task using a formula that may include inverse days until deadline and weighted importance level. Server sorts the tasks by descending score, forming the priority list.

### Step 11:

Server performs emotion analysis and adjusts priorities or module behavior.

Server applies the emotion analysis module to the original UtteranceRecord to estimate the user's emotional state.
Input: The UtteranceRecord text and possibly additional context such as recent utterances.
Output: An emotion indicator (for example, categories or scores) and adjusted internal parameters such as modified priority scores or updated module selection.

Server uses a classifier or external analysis service to obtain emotion labels like “urgent” or “calm.” Server then adjusts numeric weights in scoring functions or modifies thresholds that determine which tasks or operations receive priority. This adjustment changes the computation in modules such as scheduling and task prioritization so that they allocate more resources or earlier time slots to items aligned with the detected emotion.

### Step 12:

Server constructs a second prompt sentence for response generation and calls the generative AI model.

Server aggregates structured results from the selected module such as meeting details, extracted information items, or a priority list and builds a prompt sentence that instructs the generative AI model to generate a user-visible explanation.
Input: Structured result data (for example, meeting_title, start_time, end_time, document titles, or prioritized task list).
Output: A natural language explanation sentence generated by the generative AI model.

Server formats the prompt sentence to specify what type of message is required and what information must be included or omitted. Server sends the prompt to the generative AI model, which processes the input tokens and outputs a coherent sentence. Server receives this sentence and ensures it aligns with the structured data, optionally truncating or modifying parts that do not match the actual result.

### Step 13:

Server assembles a response object and sends it to the terminal.

Server packages the generated explanation sentence and any associated structured data into a response structure.
Input: The explanation sentence from the generative AI model and the internal structured result (for example, schedule identifier, document links, or task identifiers).
Output: A response message transmitted to the terminal containing display_text and optional machine-readable fields.

Server wraps the explanation, meeting links, document identifiers, or task metadata into a response body and uses an HTTP or similar protocol to return the response to the terminal.

Server also updates internal logs and may record metrics such as processing time and chosen module.

### Step 14:

Terminal receives the response and renders it to the user.

Terminal parses the response message, extracts the explanation sentence, and updates the user interface accordingly.
Input: The response message from the server.
Output: Visual or auditory output presented to the user, such as a message bubble, list of items, or interactive controls.

Terminal shows the explanation sentence in a display element and may render additional UI components like buttons to open a calendar event, links to documents, or controls to reorder tasks. Terminal may also store parts of the response in local memory for quick access when the user interacts further.

### Step 15:

User reviews the result and optionally issues additional commands.

User reads or listens to the explanation and examines any suggested schedules, documents, or task lists displayed by the terminal.
Input: The information presented in the terminal's interface.
Output: A decision by the user to accept, modify, or reject the proposed result, expressed as further natural language utterances or UI interactions.

User may confirm a meeting time, open a document, or ask follow-up questions such as “Move the meeting to the afternoon” or “Show only high-priority tasks,” which causes the terminal to initiate a new cycle starting from Step 1.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In modern computing environments, users interact with a large number of heterogeneous software components and hardware components, including communication applications, information management systems, scheduling systems, and machine control systems. Conventional systems typically treat user instructions as isolated commands and rely on fixed, rule-based parsing logic. As a result, such systems suffer from several technical problems.

First, conventional systems have limited capability to convert unstructured user input, such as spontaneous natural language utterances, into structured task specifications that can be directly consumed by backend components. Rule-based parsers and simple intent classifiers often fail when confronted with ambiguous instructions, composite requests (e.g., a single utterance that includes both a picking task and a stock check), or domain-specific terminology. This leads to high error rates in task interpretation, frequent need for manual correction, and increased processing time, thereby degrading overall system throughput and responsiveness.

Second, conventional systems generally treat all recognized tasks with static or manually configured priority levels. They do not integrate emotion analysis of user utterances into the task scheduling logic, and they do not correlate emotional state with system context such as deadlines or resource utilization. As a consequence, the task management subsystem cannot adaptively re-prioritize tasks when the user expresses frustration, urgency, or low concern about specific items. This limits the system's ability to allocate computing resources, network bandwidth, and actuator time (for example, in robots or other machine apparatuses) to the tasks that are most critical from the user's perspective, and leads to sub-optimal scheduling and latency.

Third, when interacting with external information processing apparatuses such as schedule management apparatuses, information management apparatuses, or machine apparatuses, existing systems typically implement direct API calls based on pre-defined mappings. These systems cannot effectively orchestrate complex workflows where input needs to be translated into a multi-step, structured action plan. They also lack a generalized prompt-generation mechanism for generative artificial intelligence models, and therefore cannot exploit such models to dynamically derive processing specifications tailored to the current user input and system state.

Fourth, conventional systems do not maintain a unified processing pipeline in which (i) conversion of heterogeneous input data to normalized input data, (ii) language analysis, (iii) generative AI-based structuring of tasks, (iv) emotion analysis, (v) priority computation using emotion and context, and (vi) execution of control or processing requests to external apparatuses are tightly integrated. Instead, these steps, if present at all, are loosely coupled, which increases the number of data transformations, inter-process communications, and synchronization points between separate modules. This fragmentation causes increased latency, unnecessary memory accesses, and higher processor load.

Accordingly, there is a need for an improved computer-implemented system and processing method that: (a) reliably converts user voice data or text data into structured task specifications using generative AI models driven by dynamically generated prompt sentences; (b) analyzes user emotion from the same input data stream and combines the resulting emotion information with system state information; (c) computes task priorities based on structured task parameters, emotion information, and resource-related state information; and (d) automatically executes appropriate control requests or processing requests to external apparatuses. Such a system should improve the efficiency, accuracy, and adaptability of task orchestration while reducing processing overhead and latency in a computing environment.

The specific processing by the specific processing unit 290 of the data processing device 12 in Application Example 2 is realized by the following means.

The present invention provides a server comprising a processor and a storage unit, the processor being configured to acquire voice data or text data from a user, convert the voice data into character string data, attach user identification information and time information to the character string data, and store the result as input data in the storage unit, to perform language analysis processing on the input data to extract phrase information, syntactic information, and event information, and to classify a task type based on contents of the input data, to generate a prompt sentence based on the input data, a result of the language analysis processing, and the task type, the prompt sentence requesting a processing specification corresponding to the task type, to input the prompt sentence into a generative artificial intelligence model and obtain structured data including task content and task parameters from the generative artificial intelligence model, to execute emotion analysis processing on the input data to obtain emotion information representing an emotional state and an emotion polarity included in the input data, to calculate a priority of a task based on the task content and the task parameters included in the structured data, the emotion information, and state information including deadline information of the task and resource utilization status, to record the task content, the task parameters, and the priority as task information in a task management information storage unit, to automatically execute, based on the task information, a control request or a processing request to an external information processing apparatus or a machine apparatus, and to present the task information, an execution state of the control request, and an information search result to the user via a display apparatus or a notification apparatus, and repeatedly perform processing by acquiring, as the input data, an additional utterance or a correction utterance from the user. This enables the computing system to implement an integrated processing pipeline in which heterogeneous user input is normalized, semantically analyzed, transformed by a generative AI model into executable structured tasks via dynamically generated prompt sentences, enriched with emotion-derived priority information, and then executed against external apparatuses, thereby improving task interpretation accuracy, reducing processing latency, optimizing resource allocation based on user emotion and system state, and enhancing overall performance and adaptability of the computer-based task orchestration.

The term “user” refers to a human operator or entity that provides voice data or text data as input to the system and receives task information, execution states, or information search results from the system.
The term “voice data” refers to audio data representing spoken utterances of the user, acquired by an input device and processable by speech recognition functions.
The term “text data” refers to character-based data representing user input in written form, including messages entered via a keyboard, touch interface, or other text input mechanism.
The term “character string data” refers to a sequence of characters obtained by converting voice data into a textual representation through speech recognition processing.
The term “user identification information” refers to data that uniquely or distinguishably identifies the user who has provided the input data, such as an account identifier, device identifier, or session identifier.
The term “time information” refers to data representing a time at which the input data is generated, received, or processed, including timestamps or time intervals.
The term “input data” refers to normalized data that includes the character string data corresponding to a user utterance, together with associated metadata such as user identification information and time information, stored for subsequent processing.
The term “storage unit” refers to any memory or storage component, such as a volatile memory or non-volatile memory, configured to store the input data, structured data, and task information for processing by the processor.
The term “language analysis processing” refers to processing that analyzes the input data linguistically, including at least one of tokenization, part-of-speech tagging, syntactic parsing, named entity recognition, or semantic role labeling.
The term “phrase information” refers to data indicating word segments or expressions identified in the input data, such as noun phrases, verb phrases, or other grouped linguistic units.
The term “syntactic information” refers to data representing grammatical relationships among words or phrases in the input data, including dependency structures or constituent structures.
The term “event information” refers to data representing actions, occurrences, or states extracted from the input data, including associated arguments such as agents, objects, times, and locations.
The term “task type” refers to a classification label assigned to the input data indicating a category of processing to be performed, such as schedule management, information retrieval, task execution, or machine control.
The term “prompt sentence” refers to a text instruction generated by the processor that describes a processing specification corresponding to the task type and is supplied as input to a generative artificial intelligence model.
The term “generative artificial intelligence model” refers to a computational model configured to generate output data, such as structured task specifications, in response to an input prompt sentence, based on learned patterns from large-scale training data.
The term “structured data” refers to data in a predetermined format, such as a record or object, that includes at least task content and task parameters and is suitable for direct use by task management or control logic.
The term “task content” refers to information specifying what operation is to be performed, such as scheduling an event, retrieving a document, executing a robot action, or issuing a control command.
The term “task parameters” refers to information specifying details of a task content, including at least one of time, date, participants, object identifiers, quantities, destinations, or other contextual parameters.
The term “emotion analysis processing” refers to processing that analyzes the input data to detect an emotional state or attitude expressed by the user, such as frustration, satisfaction, urgency, or neutrality.
The term “emotion information” refers to data representing an emotional state and an emotion polarity associated with the input data, including at least one of emotion category labels and confidence scores.
The term “emotional state” refers to a qualitative indication of the user's psychological condition as inferred from the input data, such as positive, negative, or neutral affect.
The term “emotion polarity” refers to a directional characterization of emotion information, indicating whether the emotional state is positive, negative, or neutral with respect to the task or context.
The term “state information” refers to data representing current conditions relevant to task execution, including at least deadline information of tasks and resource utilization status of computing, communication, or physical resources.
The term “deadline information” refers to data indicating a time by which a task should be completed or a time window during which a task is to be executed.
The term “resource utilization status” refers to data indicating usage conditions of resources required for task execution, such as processor load, network bandwidth, memory occupancy, or availability of machine apparatuses.
The term “priority of a task” refers to a quantitative or qualitative measure indicating an execution order or urgency level of a task relative to other tasks.
The term “task information” refers to data stored in a task management information storage unit that includes at least task content, task parameters, and a priority associated with a task.
The term “task management information storage unit” refers to a storage component configured to store and manage task information used for scheduling and controlling execution of tasks.
The term “control request” refers to a command or instruction transmitted to an external information processing apparatus or a machine apparatus to cause execution of a specific operation controlled by that apparatus.
The term “processing request” refers to a request transmitted to an external information processing apparatus to cause execution of a computational operation, such as data retrieval, data update, or scheduling.
The term “external information processing apparatus” refers to a separate computing system or service that performs information processing functions, such as schedule management, document management, or task tracking, in response to a control request or a processing request.
The term “machine apparatus” refers to a physical device or equipment, such as an industrial machine, robot, or actuator system, that executes physical operations in response to control requests.
The term “display apparatus” refers to any output device configured to visually present information to the user, including at least one of a monitor, a terminal screen, or a graphical user interface.
The term “notification apparatus” refers to any output device or mechanism configured to notify the user of information, including at least one of a sound output device, a haptic device, a messaging interface, or a combined multi-modal interface.
The term “execution state of the control request” refers to data indicating a current or completed status of a control request or processing request, such as pending, executing, succeeded, or failed.
The term “information search result” refers to data obtained from an information retrieval operation performed on an external information management apparatus, including at least retrieved items and their associated metadata.
The term “additional utterance” refers to a further user input following an initial utterance, intended to refine, extend, or supplement a previously recognized task or request.
The term “correction utterance” refers to a user input indicating modification, cancellation, or correction of previously processed input data, task content, or task parameters.

In one embodiment, a server, a terminal, and a user cooperate to implement the claimed system. The server includes at least one processor, a main memory, a non-volatile storage device, and a network interface. The terminal includes at least one processor, a memory, an audio input device such as a microphone, and a display device or other notification device. The server and the terminal are connected via a communication network such as a local area network or a wide area network.

The server executes a program stored in the non-volatile storage device. The program implements modules for input data normalization, language analysis, generative AI model interfacing, emotion analysis, task priority computation, task management, external apparatus interfacing, and user presentation. The terminal executes a program that acquires user voice data or text data, attaches metadata, and communicates with the server.

The server generates a program that defines a specific data structure for each user utterance. The server uses a record format where input data is stored as an object containing at least: (i) a character string field representing the transcribed utterance, (ii) a user identification field, (iii) a time stamp field, (iv) a language code field, and (v) a session identifier field. The server, by always populating these fields, normalizes heterogeneous user inputs (voice, typed text, communication application messages) into a unified internal format.

The terminal acquires voice data from the user via the microphone. The terminal converts the analog signal into digital samples by an analog-to-digital converter, for example 16-bit linear PCM at 16 kHz. The terminal encapsulates the digital samples in an audio container format and transmits the audio data to the server using a network transport protocol such as HTTPS.

The terminal, when receiving typed text data from the user via a graphical user interface, normalizes character encoding into a standard encoding such as UTF-8 and attaches user identification information and time information before sending the text data to the server. The server, when receiving audio data, invokes a speech recognition engine. The server may use a cloud-based automatic speech recognition service or a locally installed acoustic model combined with a language model. The acoustic model may be a deep neural network, for example a convolutional neural network or a recurrent neural network, trained on audio features such as Mel-frequency cepstral coefficients. The language model may be an n-gram model or a transformer-based model. The server converts the audio data into character string data by decoding acoustic probabilities and language probabilities. The server then stores the result as input data in the storage unit together with the associated metadata.

The server performs language analysis processing on the input data. The server can use a natural language processing library or a custom module that executes the following operations: tokenization into words and punctuation symbols, part-of-speech tagging, syntactic dependency parsing, and named entity recognition. The server constructs a parse tree or dependency graph for each sentence and extracts phrase information, syntactic information, and event information. The phrase information includes, for example, noun phrases and verb phrases. The event information includes, for example, an action label, an agent role, an object role, a time role, and a location role.

The server classifies a task type by using the extracted linguistic features as input to a task-type classifier. The server may implement the classifier as a neural network model, such as a transformer encoder that receives contextual token embeddings as input and outputs probability values over a fixed set of task categories. The server can also use additional features such as the presence of temporal expressions, device identifiers mentioned in the utterance, and previously executed tasks in the same session. The server stores, for each input data record, a task type label and the corresponding confidence score.

The server generates a prompt sentence for a generative AI model. The server concatenates the original character string data, a summary of the extracted entities and roles, and the task type label into a single text instruction. The server may further include machine-readable delimiters separating sections of the prompt sentence, such as “User utterance: . . . Context: . . . Required output format: . . . ”. The prompt sentence requests a processing specification corresponding to the task type. The server uses a generative AI model such as a transformer-based language model comprising an encoder-decoder architecture or a decoder-only architecture trained on large corpora.

The server configures the generative AI model with parameters such as context window length, attention heads, layer depth, and output temperature for sampling. The model contains multiple layers of self-attention and feedforward sub-layers. During inference, the model computes a sequence of output tokens based on the prompt sentence. The server constrains the output format by including instructions in the prompt sentence that request specific fields such as “task type”, “task parameters”, and “priority hint”.

The server sends the prompt sentence to the generative AI model through an application programming interface. The server then receives model output, which typically consists of a sequence of tokens forming a structured description of the task content and task parameters. The server parses this description and converts it into structured data, such as a record containing fields for operation type, date and time values, participant identifiers, resource identifiers, quantities, or machine identifiers.

The server executes emotion analysis processing on the same input data. The server uses a separate model or service trained for sentiment and emotion classification. The server can implement a neural network model based on bidirectional recurrent layers or transformer encoders, taking as input word embeddings or subword embeddings of the character string data. The server computes an emotion vector containing scores for categories such as positive, negative, neutral, frustration, urgency, or satisfaction. The server also computes an emotion polarity value indicating a direction of emotional state. The server stores this emotion information with the associated input data.

The server calculates a priority of a task by combining multiple inputs: (i) the task content and task parameters contained in the structured data, (ii) the emotion information, and (iii) state information representing deadline information and resource utilization status. The server may use a priority computation function that integrates numeric features such as time-to-deadline, current processor load, current network utilization, and emotion intensity values.

The server can implement this function as a trained regression model or as a deterministic function with weighted sums and non-linear scaling. For example, the server may assign a base score determined by deadline, then apply a multiplier if the emotion polarity is strongly negative, and further adjust the score downward if resources are heavily loaded.

The server records the task content, the task parameters, and the computed priority as task information in a task management information storage unit. The server uses a database schema where each task record contains fields for status, creation time, last update time, internal task identifier, external identifiers associated with external apparatuses, and priority.

The server maintains indices on fields such as user identification and priority to support efficient query and scheduling operations.

The server automatically executes, based on the task information, control requests or processing requests to external information processing apparatuses or machine apparatuses. For a schedule management task, the server generates a schedule request and sends it to an external schedule management apparatus through a standardized application programming interface. For an information retrieval task, the server generates a search request and sends it to an external information management apparatus such as a document repository. For a machine control task, the server constructs a control command in a format used by an industrial controller or a robot controller and sends it through a communication protocol such as a message bus.

The server presents the task information, the execution state of each control request, and information search results to the user via the terminal. The terminal displays this information on a display apparatus. The server updates the display when the execution state changes, for example when a schedule registration completes, when a document retrieval succeeds, or when a robot operation ends. The terminal can also provide audio or haptic notifications by using the notification apparatus.

The system can control real-world apparatuses. For example, the server sends control messages to a robot controller in a factory. The robot controller uses those messages to move a robot arm to specific coordinates and to grasp or release physical objects. The server updates inventory records in response to robot actions, thereby linking the data processing pipeline directly to physical stock levels. This integration between language-based task interpretation and physical control enables technical improvements in equipment utilization and error reduction compared to systems that require manual programming of robot actions.

The server, by using the described architecture, improves computer technology in multiple ways. The server reduces processing latency by eliminating multiple intermediate translation layers that would otherwise be needed between rule-based parsers and downstream systems.

The server achieves higher accuracy in task interpretation by generating task specifications with the generative AI model using an explicit prompt sentence that encodes context and by using deep language understanding rather than simple keyword matching. The server reduces data storage overhead by normalizing heterogeneous user inputs into a single internal data structure and by storing structured task parameters instead of ambiguous free text.

The server further improves data management and computation efficiency by integrating emotion information directly into the priority computation. Conventional systems may perform sentiment analysis for reporting purposes, but they do not use the resulting emotion values as direct numeric features in a scheduling function that influences processor scheduling, network usage, and actuator time allocation. The server uses emotion data as input to a priority computation algorithm, which changes the order in which tasks are dispatched and the resources they occupy. This behavior produces a measurable improvement in responsiveness for tasks that users perceive as urgent.

The system also changes the manner in which generative AI models are used in computer systems. The server does not merely generate text for human consumption. The server constructs prompt sentences with a predefined structure that directly describes required fields for machine-executable instruction sets. The generative AI model outputs structured content that the server parses into task parameters. The server thereby uses the generative AI model as a flexible, neural parsing and completion layer that replaces a large number of hard-coded rules. This approach improves maintainability and scalability of the system and also allows adaptation to new domains without re-writing parsing logic.

The generative AI model can be trained in advance on domain-specific corpora. The server can use a training method where input text sequences and desired structured outputs are paired. A loss function such as cross-entropy is minimized by adjusting model weights through gradient descent or a similar optimization algorithm. The training data may include examples of user utterances annotated with task types, task parameters, and priority hints.

The server can fine-tune the generative model for specific domains such as manufacturing, scheduling, or customer support by using domain-specific samples.

The emotion analysis model can also be trained with labeled examples. The server can use a supervised learning approach where user utterances are labeled with emotion categories and polarity values. The model can be a neural network with an embedding layer, multiple attention layers, and a classification head. The training process minimizes an error function such as cross-entropy between predicted emotion distributions and ground-truth labels.

The server uses distinct modules and data flows that differ from conventional business workflow automation. The server first normalizes input, then performs structural language analysis, then executes a generative AI-based structuring step using a prompt sentence, and then executes a numerical priority computation that integrates emotion as a feature. At each stage, the server uses specific data structures: text fields, parse trees, entity lists, structured task records, emotion vectors, and state vectors. The server then maps the final task records to external control calls.

The technical effect arises from this non-conventional combination of operations. Because the server integrates a generative AI-derived structured output with an emotion-aware priority computation and uses the result to drive calls to external apparatuses, the server can allocate computational and physical resources in a more optimal manner. This reduces the number of failed or redundant API calls to external systems, lowers networkload by avoiding unnecessary requests, and reduces the number of physical device operations that need to be reversed due to earlier misinterpretations.

The system can be implemented in multiple embodiments. In one embodiment, the generative AI model is provided as a cloud service, and the server acts as an intermediary that formats prompt sentences and parses model outputs. In another embodiment, the generative AI model is installed locally on the same hardware as the server, and the server uses a hardware accelerator such as a graphics processing unit or a tensor processing unit to perform inference. In a further embodiment, the emotion analysis and task-type classification modules are combined into a single multi-task neural network that shares an encoder and uses separate classification heads. In yet another embodiment, the server uses different prompt sentence templates depending on the task type, to further constrain model behavior and reduce the need for post-processing.

The terminal may also take different forms. In one embodiment, the terminal is a handheld device such as a smartphone with a built-in microphone, speaker, and display. In another embodiment, the terminal is an industrial panel computer mounted near a machine, with physical buttons and indicator lights as part of the notification apparatus. The terminal may also be a head-mounted display or an augmented-reality device that overlays task information onto a user's field of view.

The system supports multiple prompt sentence examples, including but not limited to: “Analyze the following worker voice command and output a description of the required picking and stock-check tasks: ‘Pick the parts required for the next process and check if we have enough for tomorrow's batch.’”

“From the utterance ‘Set a one-hour meeting when the whole team is free this week’, generate task parameters for a scheduling task, including a time window and participant identifiers.” “Given the statement ‘This task is not progressing at all’, identify the related task and output an updated priority level and reason.”

“From the text ‘Show me yesterday's work report’, derive search conditions for a document management system, including date and document type.”

By using such prompt sentences in a systematic way, the server ensures that the generative AI model operates as a structured transformation component rather than as a generic text generator. The server uses the resulting structured outputs to drive downstream algorithms that have measurable technical effects in terms of speed, accuracy, resource utilization, and error reduction.

The user interacts with the system by providing natural language inputs and by reviewing the presented outputs. The user can refine, correct, or extend the tasks via additional utterances or correction utterances. The server treats each new input as new input data, processes it through the described pipeline, and updates the task management information accordingly. This repeated operation permits the system to adapt task structures and priorities over time in response to changing circumstances and user feedback, while maintaining the same underlying technical architecture and algorithms.

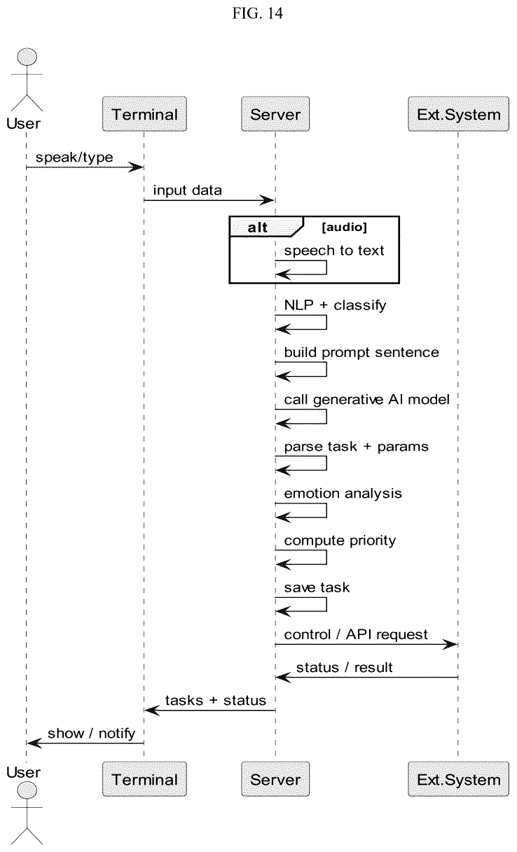

The following describes the processing flow using FIG. 14.

### Step 1:

User provides an instruction.

User speaks a natural language utterance, such as “Set a one-hour meeting when the whole team is free this week” or “Pick the parts required for the next process,” into a microphone of the terminal, or types a text message into an input field.
Input: Raw human speech or raw text typed by the user.
Output: Analog audio signal at the microphone input, or raw text characters in the terminal's input buffer.

User produces the content and timing of the instruction; no digital processing is performed by the user.

### Step 2:

Terminal converts raw input to digital input data and attaches metadata.

Terminal digitizes the analog audio signal via an A/D converter, for example at 16 kHz and 16 bits per sample, and stores the resulting samples in a buffer. Terminal, for text input, normalizes the character encoding to UTF-8 and trims leading and trailing whitespace. Terminal then creates an input packet containing: (i) a data field (audio samples or UTF-8 text), (ii) a user identifier, (iii) a timestamp, and (iv) a session identifier. Terminal sends this packet to the server via a network protocol such as HTTPS.
Input: Analog audio signal or raw text characters from the user.
Output: A digital input packet including audio or text data plus metadata (user ID, time, session ID) transmitted to the server.

Terminal performs data conversion (analog-to-digital or encoding normalization) and metadata attachment, thereby transforming human input into structured digital input data.

### Step 3:

Server performs speech recognition when necessary.

Server inspects the input packet type. When the packet contains audio data, server forwards the audio samples to a speech recognition module. The module computes acoustic features such as Mel-frequency cepstral coefficients from the audio samples, feeds them into an acoustic model (for example, a neural network), and decodes the most likely sequence of text tokens using a language model. Server then replaces the audio field with the recognized character string and sets a language code, and stores the result as input data in an internal storage unit.
Input: Input packet containing audio samples and metadata.
Output: Normalized input record containing character string data, language code, user ID, timestamp, and session ID.

Server executes feature extraction and probabilistic decoding operations to convert time-series audio data into a discrete character sequence.

### Step 4:

Server performs language analysis on the character string data.

Server loads a language analysis module and receives the character string from the input record. Server tokenizes the string into tokens, tags each token with a part-of-speech label, and applies a syntactic parser to compute dependency relations or a phrase-structure tree.

Server then detects named entities such as dates, times, locations, person names, device names, and identifiers. Server writes phrase information, syntactic information, and event information (action-argument structures) back into the input record as structured fields.
Input: Normalized input record with character string data and metadata.
Output: Enriched input record including token list, POS tags, parse structure, entities, and event structures.

Server performs symbolic and statistical data processing on the text to derive structured linguistic attributes from raw character sequences.

### Step 5:

Server classifies the task type.

Server uses the enriched input record as input to a task type classifier. Server extracts numerical feature vectors from the tokens (for example, word embeddings) and concatenates them with features indicating the presence of time expressions, device references, and prior tasks in the same session. Server feeds this feature vector into a classification model or rule engine to obtain a probability distribution over predefined task categories (for example, schedule management, information retrieval, machine control). Server selects the category with the highest probability as the task type and stores the task type label and confidence in the input record.
Input: Enriched input record with linguistic features and entities.
Output: Task type label and confidence score attached to the record.

Server executes vector computations and classification logic to transform linguistic features into a discrete task type.

### Step 6:

Server generates a prompt sentence for the generative AI model.

Server constructs a prompt sentence by concatenating (i) a description of the user utterance, (ii) a summary of extracted entities and events, and (iii) the task type label, using a predefined template. For example, server may generate:
“User utterance: ‘Pick the parts required for the next process.’
Extracted entities: {process_step: next, product: current_product}.
Task type: machine_control.

Output a description of the required task with fields: task type and task parameters.”

Server thus forms a single string that encodes all necessary context and requested output format.
Input: Input record with character string, entities, events, and task type.
Output: Prompt sentence string suitable for input to a generative AI model.

Server performs string assembly and formatting operations to convert structured internal fields into a linear text instruction.

### Step 7:

Server invokes the generative AI model and obtains structured task data.

Server passes the prompt sentence to a generative AI model interface. The model internally encodes the prompt sentence into token embeddings, propagates them through multiple self-attention and feedforward layers, and decodes an output sequence of tokens. Server receives the generated tokens and reconstructs them into a textual output that describes task content and task parameters in a structured way. Server then parses that textual output according to the instructions in the prompt and maps fields such as “operation type,” “date,” “time window,” “participant,” “resource ID,” and “quantity” into a structured data record.
Input: Prompt sentence describing the user utterance, context, and requested output fields.
Output: Structured task record including task content and task parameters derived from the model output.

Server transforms the model's token sequence into a machine-usable data structure by parsing and field extraction.

### Step 8:

Server performs emotion analysis on the input data.

Server takes the original character string from the input record and converts each token into an embedding vector. Server feeds the sequence of embedding vectors into an emotion classification model, which may use attention or recurrent layers to generate an aggregate representation. Server applies one or more classification layers to compute probability scores for emotion categories such as positive, negative, neutral, frustration, urgency, or satisfaction.

Server also computes an emotion polarity from these scores. Server stores the emotion category scores and polarity as emotion information in association with the input record and corresponding task record.
Input: Character string data and its tokenization from the input record.
Output: Emotion information including category scores and polarity values.

Server executes numerical matrix multiplications and non-linear activations on the embeddings to derive a low-dimensional emotion vector.

### Step 9:

Server obtains state information and computes task priority.

Server retrieves state information from internal modules, including deadline information for related tasks and resource utilization status (processor load, network load, machine availability). Server combines numerical features from the structured task record (such as time-to-deadline and quantity), the emotion information (for example, negative intensity score), and the state information. Server feeds these features into a priority computation function that may consist of weighted sums, scaling factors, and threshold-based adjustments.

Server outputs a numeric priority value or ordinal priority level.
Input: Structured task record (task content and parameters), emotion information, and state information from resource monitors and scheduling tables.
Output: Computed priority value for the task.

Server performs arithmetic operations and rule-based adjustments to map multi-dimensional numerical features into a single priority metric.

### Step 10:

Server records task information in the task management storage.

Server assembles a task information object containing at least task content, task parameters, priority, user ID, creation time, and status. Server inserts this object as a row in a task table within a database or updates an existing row if the task corresponds to a previously created task. Server may create indexes on fields such as user ID and priority to support efficient retrieval and sorting.
Input: Task content and task parameters from the structured task record, computed priority, and associated metadata.
Output: Persistent task information stored in a task management information storage unit.

Server executes database insert or update operations to transform transient computation results into persistent scheduling data.

### Step 11:

Server generates and issues control or processing requests to external apparatuses.

Server inspects the task content and task type to determine which external apparatus should be contacted. For a schedule management task, server constructs an API request containing start time, end time, participants, and event description, and sends it to an external scheduling system. For an information retrieval task, server constructs a query including keywords, date range, and document type, and sends it to an external information management system. For a machine control task, server constructs a control message specifying target device, operation mode, coordinates, or quantities, and sends it to a machine controller or robot controller using a communication protocol. Server stores any external IDs returned by the apparatus into the corresponding task information record.
Input: Task information including task content, parameters, and priority, plus configuration data for external apparatus interfaces.
Output: Outgoing control or processing requests to external apparatuses and external identifiers recorded in the database.

Server transforms abstract task definitions into apparatus-specific command or request formats and transmits them over the network.

### Step 12:

Server monitors execution states and updates task records.

Server receives status responses from external apparatuses, such as confirmation of schedule creation, completion or failure notifications for document retrieval, or feedback messages from machine controllers indicating operation progress. Server parses these responses to extract execution states and error codes. Server updates the corresponding task records in the task management storage with new status values (for example, pending, running, completed, failed) and may adjust internal logs or metrics.
Input: Response messages from external scheduling systems, information systems, or machine controllers.
Output: Updated task records with current execution states and associated diagnostic information.

Server applies parsing and mapping operations to convert protocol-specific responses into standardized status fields in the task table.

### Step 13:

Server prepares presentation data and sends it to the terminal.

Server selects task records relevant to the user based on user ID, session ID, and priority.

Server sorts the tasks by priority and filters them by status or time window. Server converts selected task information, execution states, and any information search results into a presentation structure, such as a list of labeled entries with fields like “title,” “deadline,” “status,” and “link.” Server serializes this structure into a response message and transmits it to the terminal.
Input: Task records, execution states, and search result data stored in the task management and information management components.
Output: Presentation data package describing tasks and results, sent to the terminal.

Server performs selection, sorting, and formatting operations to transform internal database records into a user-facing summary.

### Step 14:

Terminal presents information to the user and accepts further corrections or additions.

Terminal receives the presentation data package from the server and decodes it. Terminal maps each entry to visual elements on the display, such as lists, icons, and status indicators.

Terminal may also convert brief summaries into synthetic speech using a text-to-speech module. Terminal enables user interaction controls, such as buttons for confirming tasks, fields for correction utterances, or icons for opening retrieved documents. When the user provides an additional utterance or a correction utterance (for example, “Move this meeting to Friday afternoon” or “Increase the quantity to fifty units”), terminal captures that new input and repeats Steps 1 and 2 to send new input data to the server.
Input: Presentation data from the server and any new user utterances or corrections.
Output: Visual or audio display of task and status information to the user, and newly formed input packets for subsequent processing.

Terminal converts structured presentation data into human-perceivable output and transforms new human inputs into fresh digital input packets, closing the interaction loop.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like.

The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

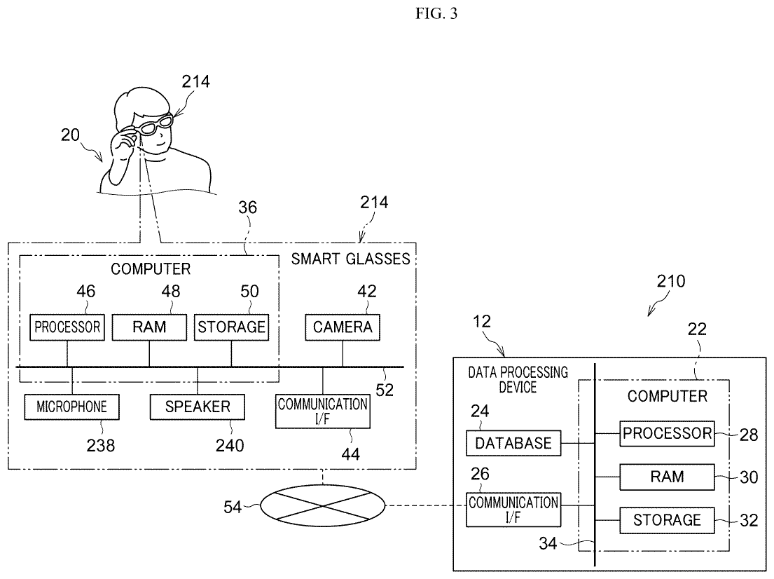

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

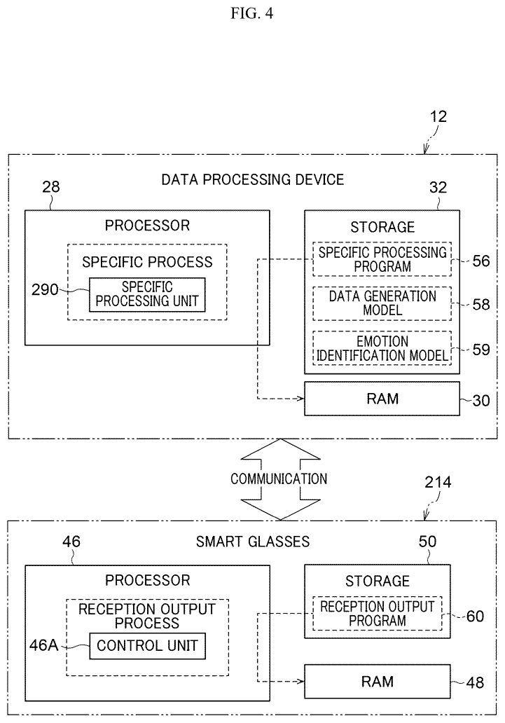

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

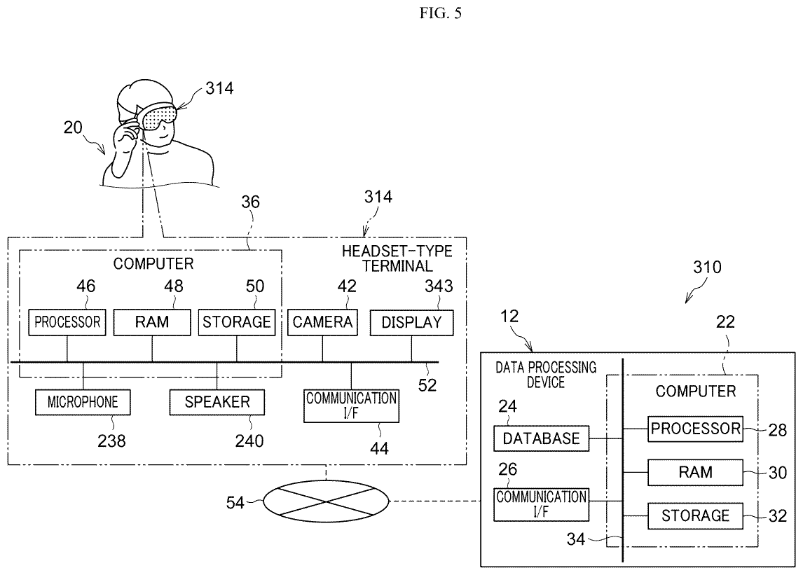

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

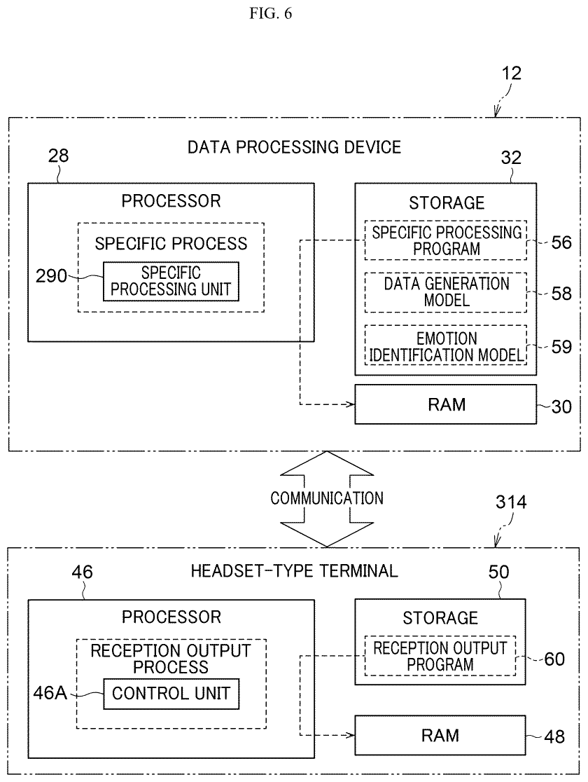

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

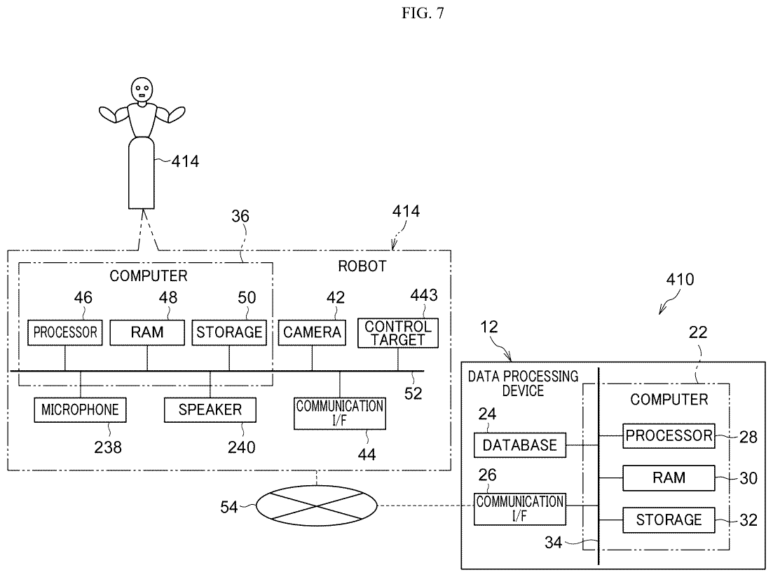

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area Network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

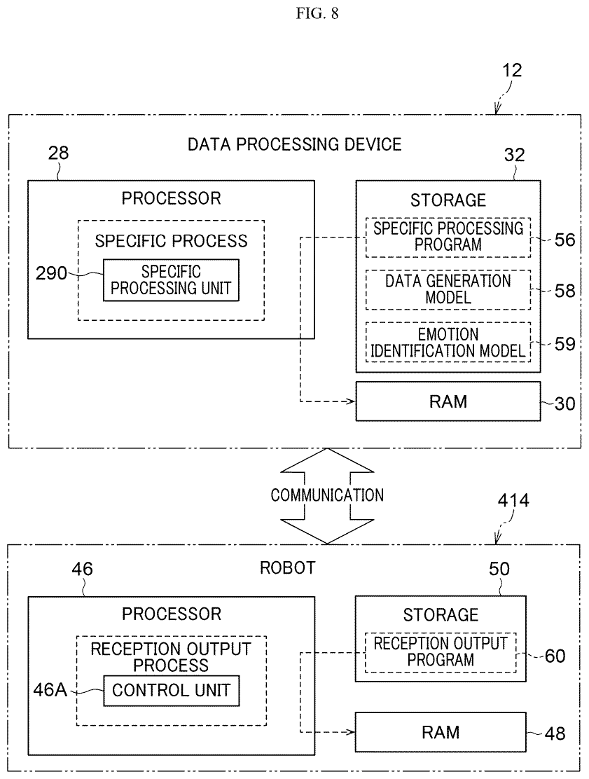

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

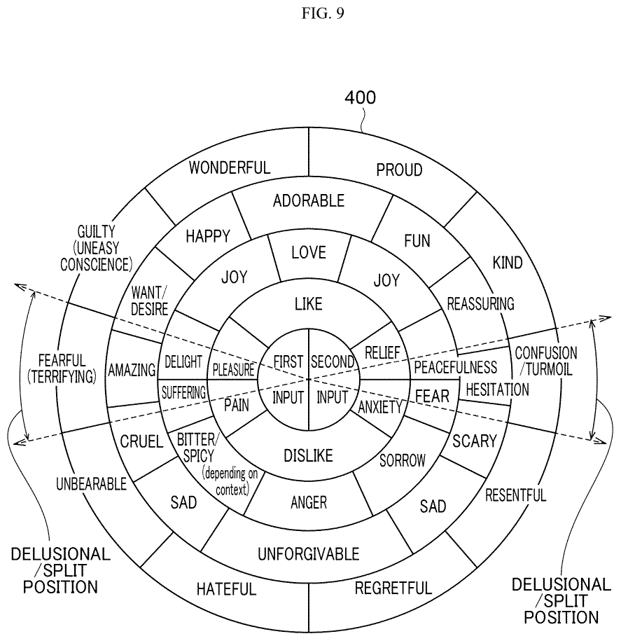

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University).

Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

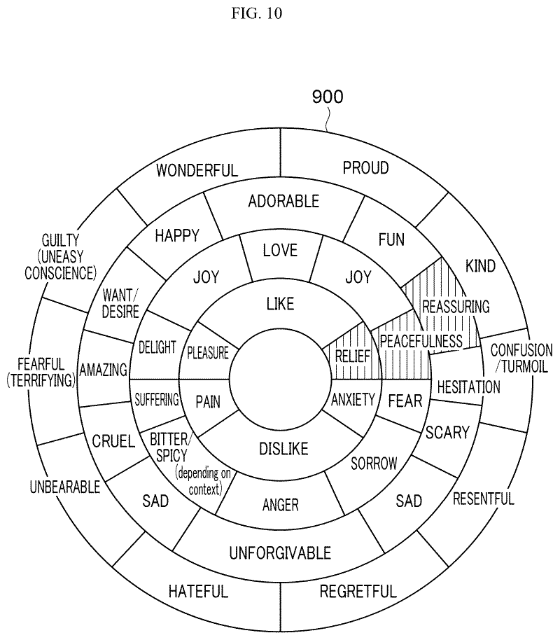

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive utterance data of a user, the utterance data being acquired from a terminal of the user via a communication unit, and normalize the utterance data as character string data and store the character string data,
transmit the character string data, as a prompt sentence, to a natural language processing unit including a generative AI model, and obtain, from the generative AI model, an analysis result as structured data including at least an intent type, time information, target information, participant information, and priority information,
generate internal action plan data including at least an action type, a service type to be used, a processing target period, and a processing target set in accordance with the intent type included in the structured data, and store the internal action plan data in a storage unit,
transmit an inquiry request, based on the internal action plan data, via an external communication interface to at least one of a schedule management unit, an information management unit, and a task management unit, and acquire at least one of schedule data, information data, and task data,
derive a common free time period by comparing, on a time axis, occupied time periods of a plurality of entities included in the acquired schedule data, and determine a continuous time period corresponding to a predetermined time length so as to automatically set a meeting schedule,
perform a search process and a relevance evaluation process on creation time information and content information included in the acquired information data, and automatically specify, as a presentation candidate, an information item that most closely matches the target information and the time information included in the structured data,
perform extraction processing and sorting processing on due date information and status information included in the acquired task data, and automatically rearrange tasks due on a current date or overdue tasks in ascending order of their due dates so as to determine task priorities,
generate a prompt sentence using structured data including at least one of the meeting schedule, the presentation candidate, and the task priorities, input the prompt sentence to the generative AI model, and obtain a natural-language notification message to be presented to the user, and
transmit the natural-language notification message to the terminal of the user via the communication unit.

### (Supplementary 2)

The system according to supplementary 1,
wherein the processor is configured to, when the intent type in the internal action plan data is determined to relate to schedule management, acquire schedule data of a plurality of entities from the schedule management unit, calculate the common free time period based on the time information and the participant information extracted using the generative AI model, automatically select, from the common free time period, a time period satisfying a predetermined condition to register the meeting schedule, and generate, based on a registration result, a natural-language confirmation message by using a prompt sentence for the generative AI model, and transmit the natural-language confirmation message to the user.

### (Supplementary 3)

The system according to supplementary 1,
wherein the processor is configured to, when the intent type in the internal action plan data is determined to relate to information retrieval or task management, filter and rank the information data or the task data acquired from the information management unit or the task management unit in accordance with parameter extraction results based on a prompt sentence using the generative AI model, and re-input, to the generative AI model, structured data including a ranking result so as to generate, as a natural-language sentence, an explanatory text of a retrieval result or a summary text of the task priorities, and present the natural-language sentence to the user.

### Application Example 1

### (Supplementary 1)

A system comprising a processor and a terminal,
wherein the processor is configured to
receive, via the terminal, a voice utterance from a user and convert the utterance into character string data by using a speech recognition unit,
generate a prompt sentence including the character string data and situation information relating to a work environment, input the prompt sentence to a generative AI model, and obtain structured command data representing an intention of the user from the generative AI model,
generate control command data on the basis of the structured command data, control a work processing device, a work apparatus, or a mobile apparatus by using the control command data, and automatically complete a physical work operation or an information processing operation,
execute an inquiry process to an information storage device that stores inventory information on the basis of the structured command data, and acquire and update the inventory information,
recognize an emotion of the user from the voice utterance, assign priorities to a plurality of tasks generated on the basis of the structured command data and the inventory information by taking into account importance and urgency, and generate task management data for displaying the priorities on the terminal, and
determine whether content of the voice utterance of the user relates to at least one of schedule management, information retrieval, and inventory management, and, when it is determined that the content relates to at least one of the schedule management, the information retrieval, and the inventory management, generate at least one of schedule data, retrieval result data, and inventory report data on the basis of an output of the generative AI model and present the at least one of the schedule data, the retrieval result data, and the inventory report data to the terminal.

### (Supplementary 2)

The system according to supplementary 1,
wherein the processor is configured to, when the control command data relates to conveyance or extraction of an article, control a robot apparatus as the work processing device, the work apparatus, or the mobile apparatus, automatically execute a picking process of the article by the robot apparatus on the basis of process information and component information acquired from an information storage device, update the inventory information in accordance with a result of the picking process, and report an update result of the inventory information to the terminal.

### (Supplementary 3)

The system according to supplementary 1,
wherein the processor is configured to, when the content of the voice utterance of the user relates to schedule management, automatically determine time allocation for the plurality of tasks on the basis of the structured command data obtained from the generative AI model and the task management data, register or update schedule information in an external or internal schedule management device, and present the registered or updated schedule information to the terminal.

### Example 2

### (Supplementary 1)

A system comprising a processor,
wherein the processor is configured to
receive, from a terminal, a natural language utterance of a user obtained via an information exchange means or an electronic communication means, the natural language utterance being represented as text data,
transmit the text data to an external language analysis service or a natural language processing apparatus, and obtain, from the external language analysis service or the natural language processing apparatus, analysis result data in a structured data format including at least an intention, a target, time information, and participant information,
generate a first prompt sentence on the basis of the analysis result data, input the first prompt sentence to a generative AI model, and obtain, from the generative AI model, extended structured data including at least a task type, task parameters, and complement information for missing items,
select, on the basis of the extended structured data, at least one processing module associated with at least one of a schedule management function, an information management function, and a task management function, and automatically execute a task by using the selected processing module,
for automatic execution of a schedule management task, acquire availability information of a plurality of users from a schedule storage device, calculate, by computation, a common available time period satisfying a predetermined time length, and generate schedule information by registering a schedule in the common available time period,
for automatic execution of an information search task, acquire candidate information from a document storage device or an information retrieval device, and identify extracted information by ranking the candidate information on the basis of at least the analysis result data and the extended structured data,
for automatic execution of a task management task, acquire task information from a task storage device or an external task management service, calculate a priority score by computation on the basis of at least deadline information and importance information included in the task information, and generate a priority list in which the tasks are arranged according to the priority score,
recognize an emotion of the user from the natural language utterance, and correct at least one of the priority score and selection of the processing module in accordance with the emotion, and
generate a second prompt sentence on the basis of structured data including at least one of a result of execution of the task, the extracted information, and the priority list, input the second prompt sentence to a generative AI model, obtain, from the generative AI model, an explanation sentence in natural language, and transmit the explanation sentence to the terminal.

### (Supplementary 2)

The system according to supplementary 1,
wherein the processor is configured to, in a case where the intention included in the extended structured data indicates schedule management, acquire schedule information of a plurality of users from the schedule storage device or an external schedule management service, extract available time periods from the schedule information, select, by computation, a common available time period satisfying a predetermined condition, automatically set a schedule in the selected common available time period, and transmit, to the terminal, a text datum in natural language describing a result of the automatic setting of the schedule.

### (Supplementary 3)

The system according to supplementary 1,
wherein the processor is configured to, in a case where the intention included in the extended structured data indicates information search, transmit a search request to an information management apparatus or an external information management service, acquire candidate information in response to the search request, narrow down and rank the candidate information on the basis of at least a time condition, a creator condition, and a content condition included in the extended structured data, generate, by means of the generative AI model, at least one of a summary and an explanation for higher-ranked candidate information, and cause the terminal to present the at least one of the summary and the explanation.

### Application Example 2

### (Supplementary 1)

A system comprising a processor,
wherein the processor is configured to
acquire voice data or text data from a user, convert the voice data into character string data, attach user identification information and time information to the character string data, and store the result as input data in a storage unit,
perform language analysis processing on the input data to extract phrase information, syntactic information, and event information, and classify a task type based on contents of the input data,
generate a prompt sentence, based on the input data, a result of the language analysis processing, and the task type, the prompt sentence requesting a processing specification corresponding to the task type, input the prompt sentence into a generative AI model, and obtain structured data including task content and task parameters from the generative AI model,
execute emotion analysis processing on the input data to obtain emotion information representing an emotional state and an emotion polarity included in the input data, calculate a priority of a task based on the task content and the task parameters included in the structured data, the emotion information, and state information including deadline information of the task and resource utilization status, record the task content, the task parameters, and the priority as task information in a task management information storage unit, and automatically execute, based on the task information, a control request or a processing request to an external information processing apparatus or a machine apparatus, and
present the task information, an execution state of the control request, and an information search result to the user via a display apparatus or a notification apparatus, and repeatedly perform processing by acquiring, as the input data, an additional utterance or a correction utterance from the user.

### (Supplementary 2)

The system according to supplementary 1,
wherein the processor is configured to, when the task type is classified as a type related to schedule management, calculate free time periods of participants based on time information and participant information included in the structured data and schedule information acquired from an external schedule management apparatus, register schedule information corresponding to the free time periods in the external schedule management apparatus, and record a result of the registration as the task information.

### (Supplementary 3)

The system according to supplementary 1,
wherein the processor is configured to, when the task type is classified as a type related to information retrieval, select candidate information based on search condition information included in the structured data and document information or record information acquired from an external information management apparatus, present, to the user via the display apparatus or the notification apparatus, information having high relevance among the candidate information as proposal information, and record an access procedure to the proposal information as the task information.

What is claimed is:

1. A system comprising:
circuitry configured to:
receive, via a communication interface coupled to a packet-switched network, utterance data from a terminal device, apply a speech recognition model to the utterance data to generate character string data, and store the character string data in a storage device;
transmit the character string data as a prompt sentence to a natural language processing unit comprising a generative AI model, and obtain from the generative AI model an analysis result as structured data comprising at least an intent type, time information, target information, participant information, and priority information;
generate internal action plan data comprising at least an action type, a processing category, a processing target period, and a processing target based on the intent type included in the structured data, and store the internal action plan data in the storage device;
transmit an inquiry request based on the internal action plan data via the communication interface to at least one of a first data management unit, a second data management unit, and a third data management unit, and acquire at least one of first management data, second management data, and third management data;
generate task information based on the acquired data and the internal action plan data, and transmit the task information to the terminal device and to at least one external processing unit via the communication interface; and
apply an emotion recognition model to the character string data to generate an emotional state representation, and adjust a priority parameter of the task information based on the emotional state representation.

2. The system according to claim 1, wherein the circuitry is configured to apply a natural language understanding model to the character string data to identify urgency indicators and stress indicators in the utterance data, and incorporate the urgency indicators and the stress indicators as additional inputs to the emotion recognition model.

3. The system according to claim 2, wherein the circuitry is configured to apply a sentiment analysis model to the character string data to generate a sentiment score, and combine the sentiment score with the emotional state representation to compute a composite priority adjustment factor for the task information.

4. The system according to claim 3, wherein the circuitry is configured to re-rank pending task information items stored in the storage device based on the composite priority adjustment factor, and transmit updated priority rankings to the terminal device via the communication interface.

5. The system according to claim 4, wherein the circuitry is configured to generate a notification message based on the updated priority rankings and transmit the notification message to the terminal device, the notification message identifying tasks whose priority has changed and providing explanatory text based on the emotional state representation.

6. The system according to claim 1, wherein the circuitry is configured to apply a named entity recognition model to the structured data to identify temporal entities comprising date entities and time entities, and participant entities, and transmit registration data to the first data management unit via the communication interface when the intent type is classified as a time-based coordination type.

7. The system according to claim 6, wherein the circuitry is configured to acquire availability data from the first data management unit for each identified participant entity, identify free time periods based on the availability data, and register coordination information corresponding to the identified free time periods in the first data management unit.

8. The system according to claim 1, wherein the circuitry is configured to select candidate data items from the second data management unit based on search condition information included in the structured data when the intent type is classified as a data retrieval type, and present data items having high relevance as proposal information to the terminal device.

9. The system according to claim 8, wherein the circuitry is configured to apply a relevance scoring model to the candidate data items using the target information and participant information from the structured data, and rank the candidate data items by relevance score prior to transmission to the terminal device.

10. The system according to claim 1, wherein the circuitry is configured to receive audio data from the terminal device, apply the speech recognition model to the audio data to generate the character string data, and apply a prosody analysis model to the audio data to extract pitch contours and energy features for input to the emotion recognition model.

11. The system according to claim 10, wherein the circuitry is configured to apply a speaker diarization model to the audio data to identify utterance segments attributed to the user, and apply the speech recognition model to the identified user utterance segments to generate the character string data.

12. The system according to claim 1, wherein the circuitry is configured to apply a context tracking model to a sequence of character string data items received from the terminal device over a session, maintain a context representation across multiple utterances, and incorporate the context representation in the prompt sentence transmitted to the generative AI model.

13. The system according to claim 12, wherein the circuitry is configured to update the context representation in the storage device upon receipt of each new utterance data item, and apply the updated context representation in the generation of internal action plan data for subsequent utterances.

14. The system according to claim 1, wherein the circuitry is configured to monitor execution status of the task information by receiving status update data from the external processing unit, update the task information stored in the storage device based on the status update data, and transmit updated task status notifications to the terminal device.

15. The system according to claim 14, wherein the circuitry is configured to apply a completion verification model to the status update data to determine whether the task information has been completed, and generate a completion confirmation message for transmission to the terminal device.

16. The system according to claim 1, wherein the circuitry is configured to accumulate character string data items, analysis results, emotional state representations, and task information in the storage device, and apply a pattern analysis model to the accumulated data to identify recurring intent types and associated priority adjustment patterns.

17. The system according to claim 16, wherein the circuitry is configured to update generation rules for the prompt sentence and priority adjustment parameters based on the identified recurring intent types and priority adjustment patterns, to improve intent interpretation accuracy and priority alignment over time.

18. A system comprising:
circuitry configured to:
receive, via a communication interface coupled to a packet-switched network, utterance data from a terminal device, apply a speech recognition model to generate character string data, and transmit the character string data as a prompt sentence to a generative AI model to obtain an analysis result comprising an intent type, time information, target information, participant information, and priority information;
generate internal action plan data based on the intent type, transmit inquiry requests to at least one of a first data management unit, a second data management unit, and a third data management unit, and generate task information based on acquired data and the internal action plan data;
apply an emotion recognition model to the character string data and prosodic features extracted from the utterance data to generate an emotional state representation, and adjust a priority parameter of the task information based on the emotional state representation;
apply a context tracking model to maintain a context representation across multiple utterances, incorporate the context representation in subsequent prompt sentences, and re-rank pending task information items based on a composite priority adjustment factor derived from the emotional state representation; and
transmit updated task information and priority rankings to the terminal device and to external processing units via the communication interface.

19. The system according to claim 18, wherein the circuitry is configured to accumulate character string data items, analysis results, and emotional state representations in the storage device, apply a pattern analysis model to identify recurring intent types and priority adjustment patterns, and update prompt sentence generation rules and priority adjustment parameters based on the identified patterns.

20. A method comprising:
receiving, via a communication interface coupled to a packet-switched network, utterance data from a terminal device, applying a speech recognition model to the utterance data to generate character string data, and storing the character string data in a storage device;
transmitting the character string data as a prompt sentence to a natural language processing unit comprising a generative AI model, and obtaining from the generative AI model an analysis result as structured data comprising at least an intent type, time information, target information, participant information, and priority information;
generating internal action plan data comprising at least an action type, a processing category, a processing target period, and a processing target based on the intent type included in the structured data, and storing the internal action plan data in the storage device;
transmitting an inquiry request based on the internal action plan data via the communication interface to at least one of a first data management unit, a second data management unit, and a third data management unit, and acquiring at least one of first management data, second management data, and third management data;
generating task information based on the acquired data and the internal action plan data, and transmitting the task information to the terminal device and to at least one external processing unit via the communication interface; and
applying an emotion recognition model to the character string data to generate an emotional state representation, and adjusting a priority parameter of the task information based on the emotional state representation.
